(19) United States
(12) Patent Application Publication
(10) Pub. No.: US 2026/0210448 A1
(43) Pub. Date: Jul. 23, 2026

(54) FLOW PATH SWITCHING VALVE

(71) Applicant: MARELLI CORPORATION, Saitama (JP)

(72) Inventors: Masahiro KATOU, Saitama (JP); Tomohiro MARUYAMA, Saitama (JP); Norimitsu MATSUDAIRA, Saitama (JP); Toru KAWAMATA, Saitama (JP); Kouji HIRONO, Saitama (JP); Satoshi SHIMIZU, Saitama (JP)

(21) Appl. No.: 19/141,851

(22) PCT Filed: Nov. 16, 2023
(86) PCT No.: PCT/JP2023/041251

§ 371 Date: Jun. 20, 2025

(30) Foreign Application Priority Data
Dec. 20, 2022 (JP) 2022-203747
Apr. 6, 2023 (JP) 2023-062269
Apr. 27, 2023 (JP) 2023-073753
Aug. 1, 2023 (JP) 2023-125572

(51) Int. Cl. F16K 11/076; F16K 27/04

(52) U.S. Cl. CPC F16K 11/076; F16K 27/04

(57) ABSTRACT

A flow path switching valve includes: a housing including a main body part having a cylindrical inner wall part and a plurality of ports opening in a circumferential direction, a bottom part covering a first end of the main body part in a center axis direction, and a cover part covering a second end of the main body part in the center axis direction; a valve body stored inside the housing so as to be rotatable about the center axis, the valve body including a set of a first valve body and a second valve body positioned around the center axis, a rotating shaft extending in the center axis direction, connecting the first valve body and the second valve body to be movable in a radial direction; and a biasing member that biases the first valve body and the second valve body toward the inner wall part.

### CROSS-REFERENCE TO RELATED APPLICATIONS

This application is a U.S. national stage filing under 35 U.S.C. § 371 of International Patent Application No. PCT/JP2023/041251, filed Nov. 16, 2023, which international application claims the benefit of and priority to Japanese Application No. 2022-203747, filed Dec. 20, 2022, Japanese Application No. 2023-125572, filed Aug. 1, 2023, Japanese Application No. 2023-073753, filed Apr. 27, 2023, and Japanese Application No. 2023-062269, filed Apr. 6, 2023, the entire contents of these applications are incorporated herein by reference.

### TECHNICAL FIELD The present invention relates to a flow path switching valve that switches a flow path of a fluid.

### CONVENTIONAL TECHNOLOGY

JP2022-535565A discloses a flow path switching valve having a cylindrical valve main body part, and a valve plug provided in the valve main body part so as to rotate relative to the valve main body part about a rotating shaft, the valve plug having a seal that abuts against a side wall in the valve main body part.

### SUMMARY OF THE INVENTION

The flow path switching valve described in JP2022-535565A is configured such that the seal part abuts against the wall part of the valve main body from the inside, so if the biasing force between the seal part and the wall part is increased to improve sealing performance, a force is applied in a direction perpendicular to the rotating shaft, which increases the load on the rotating shaft.

The present invention provides a flow path switching valve that does not impair sealing performance and does not increase load on a rotating shaft.

In one aspect of the present invention, the flow path switching valve, includes: a housing including a main body part having a cylindrical inner wall part and a plurality of ports opening in a circumferential direction, a bottom part covering a first end of the main body part in a center axis direction, and a cover part covering a second end of the main body part in the center axis direction; a valve body stored inside the housing so as to be rotatable about the center axis, the valve body including a set of a first valve body and second valve body positioned around the center axis, the valve body being in sliding contact with the inner wall part to switch the connection state between the plurality of ports; a rotating shaft extending in the center axis direction, connecting the first valve body and the second valve body so as to be movable in a radial direction, and switching rotational position of the first valve body and the second valve body by rotating the rotating shaft; and a biasing member that biases the first valve body and the second valve body toward the inner wall part.

A flow path switching valve, includes: a housing including a main body part having a cylindrical inner wall part and a plurality of ports opening in a circumferential direction, a bottom part covering a first end of the main body part in a center axis direction, and a cover part covering a second end of the main body part in the center axis direction a valve body stored inside the housing so as to be rotatable about the center axis, the valve body including a set of a first valve body and a second valve body positioned around the center axis, the valve body being in sliding contact with the inner wall part to switch the connection state between the plurality of ports; a rotating shaft extending in the center axis direction, connecting the first valve body and the second valve body so as to be movable in a radial direction, and switching rotational position of the first valve body and the second valve body by rotating the rotating shaft; and a biasing member that biases the first valve body and the second valve body toward the inner wall part.

With the above aspect, the first valve body and the second valve body that constitute the valve body are provided around the center axis and are biased toward the inner wall part by the biasing member, so a load in the bending direction can be prevented from being generated on the rotating shaft, and the biasing force can improve the sealing performance between the first valve body and the second valve body.

### BRIEF DESCRIPTION OF THE DRAWINGS

FIG. 1 is a perspective view of a flow path switching valve according to a first embodiment of the present invention;

FIG. 2 is a transparent perspective view of a flow path switching valve;

FIG. 3 is a perspective view of a valve body and a rotating shaft;

FIG. 4 is an exploded perspective view of a valve body;

FIG. 5 is a lateral cross-sectional view of a flow path switching valve;

FIG. 6 is a longitudinal cross-sectional view of a flow path switching valve;

FIG. 7 is a lateral cross-sectional view of a flow path switching valve;

FIG. 8 is a lateral cross-sectional view of a flow path switching valve;

FIG. 9 is a lateral cross-sectional view of a flow path switching valve according to a modified example of the first embodiment;

FIG. 10 is a lateral cross-sectional view of a modified example of a flow path switching valve;

FIG. 11 is a lateral cross-sectional view of a flow path switching valve according to another modified example of the first embodiment;

FIG. 12 is a lateral cross-sectional view of a flow path switching valve according to another modified example;

FIG. 13 is a lateral cross-sectional view of a flow path switching valve according to yet another modified example of the first embodiment;

FIG. 14 is a lateral cross-sectional view of a flow path switching valve according to yet another modified example;

FIG. 15 is a lateral cross-sectional view of a flow path switching valve according to yet another modified example;

FIG. 16 is a lateral cross-sectional view of a flow path switching valve according to yet another modified example;

FIG. 17 is a perspective view of a flow path switching valve according to a second embodiment of the present invention;

18 is an exploded perspective view of FIG. 17;

19 is a cross-sectional view along line XIX-XIX in FIG. 17;

FIG. 20 is a plan view of the flow path switching valve, depicting a state in which a cover part is removed from a housing;

FIG. 21 is a perspective view of the valve body, the rotating shaft, and the biasing member in an assembled state;

FIG. 22 is an exploded perspective view of FIG. 21;

FIG. 23A is a plan view of the first valve body;

FIG. 23B is a front view of the first valve body;

FIG. 24 is a cross-sectional view along line XXIV-XXIV in FIG. 23B;

FIG. 25A is a plan view of the second valve body;

FIG. 25B is a front view of the second valve body;

FIG. 26 is a perspective view of a state in which a valve body, a rotating shaft, and a biasing member are combined in a flow path switching valve according to a modified example of the second embodiment of the present invention;

FIG. 27 is an exploded perspective view of FIG. 26;

FIG. 28 is a plan view of FIG. 26;

FIG. 29 is a plan view of a flow path switching valve according to another modified example of the second embodiment of the present invention;

FIG. 30 is a perspective view of the rotating shaft in FIG. 29;

FIG. 31 is a plan view of a flow path switching valve according to yet another modified example of the second embodiment of the present invention, depicting a state in which the cover part is removed from the housing;

FIG. 32 is a configuration diagram depicting an example of a fluid circuit to which a flow path switching valve is applied; and

FIG. 33 is a configuration diagram for describing first to third connection states of the flow path switching valve.

### DESCRIPTION OF THE PREFERRED EMBODIMENTS

Hereinafter, embodiments of the present invention will be described with reference to the accompanying drawings.

### First Embodiment

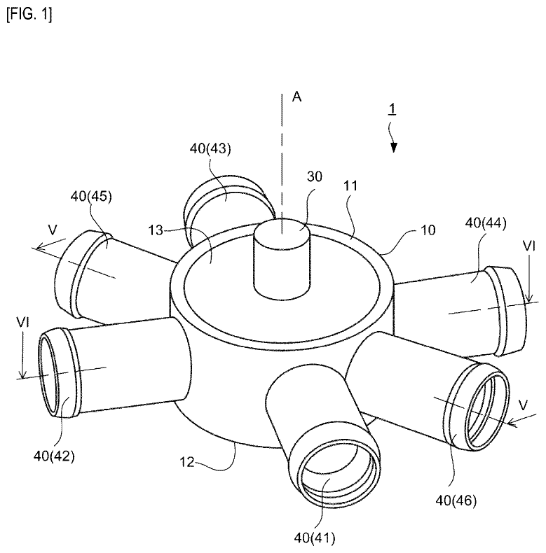

Hereinafter, a flow path switching valve 1 according to a first embodiment of the present invention will be described with reference to FIG. 1 to FIG. 16.

First, the overall configuration of a flow path switching valve 1 will be described with reference to FIG. 1 to FIG. 4.

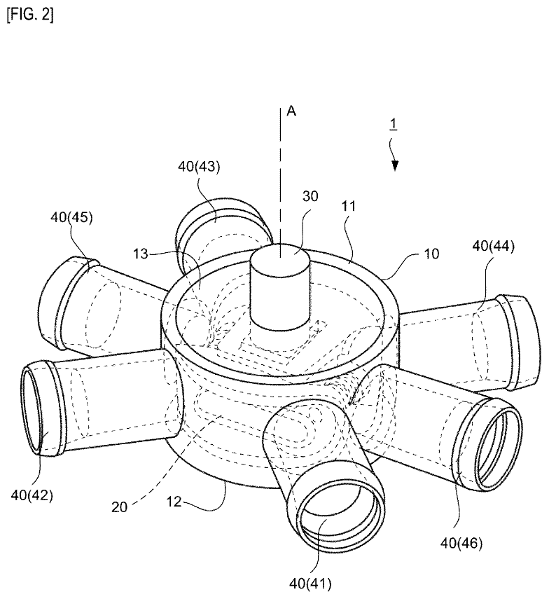

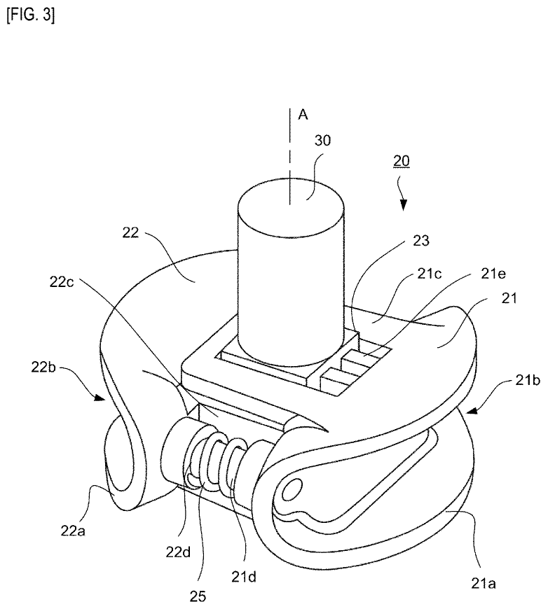

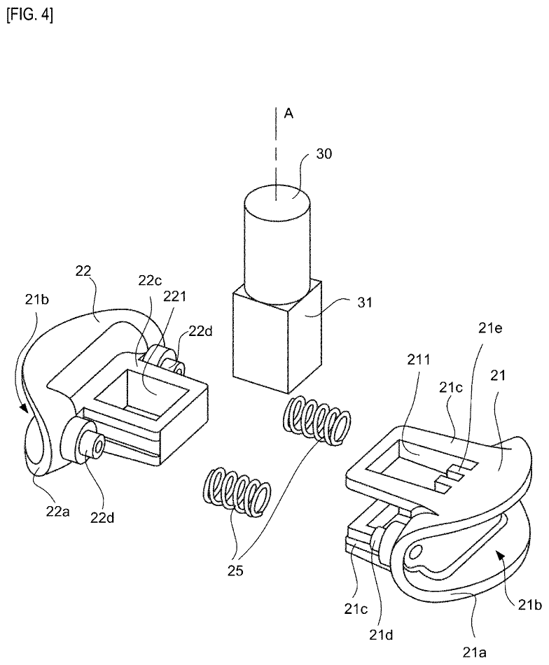

FIG. 1 is a perspective view of a flow path switching valve 1 according to the present embodiment, and FIG. 2 is a perspective transparent view of the flow path switching valve 1. FIG. 3 is a perspective view of the valve body 20, and FIG. 4 is an exploded perspective view of the valve body 20.

As depicted in FIG. 1 and FIG. 2, the flow path switching valve 1 includes a housing 10, and a valve body 20 that switches the flow path, stored inside the housing 10.

In the following, the direction along the center axis A of the housing 10 (center axis of rotation of the valve body 20) will be referred to as the “center axis direction (center axis A direction)”, the direction from the center axis A of the housing 10 toward the outer diameter will be referred to as the “radial direction”, and the direction in which the valve body 20 rotates in the housing 10 will be referred to as the “rotational direction”.

The housing 10 has a main body part 11 having a cylindrical inner wall part 11a, six ports 40 (first to sixth ports 41 to 46) that protrude in the circumferential direction from the main body part 11 and connect with the inner wall part 11a, a bottom part 12 that covers a first end of the main body part 11 in the direction of the center axis A, and a cover part 13 that covers a second end part of the main body part 11 in the direction of the center axis A.

A valve body 20 (first valve body 21 and second valve body 22) is provided inside the housing 10 and is stored so as to be rotatable around a center axis A. The valve body 20 is capable of being displaced in the radial direction relative to the rotating shaft 30. As depicted in FIG. 3 and FIG. 4, the valve body 20 is constituted by a set of a first valve body 21 and a second valve body 22 provided at positions facing each other centered around a center axis A.

The first valve body 21 and the second valve body 22 are provided with a rotating shaft 30 that extends from the cover part 13 in the direction of the center axis A of the housing 10, and switch the rotational positions of the first valve body 21 and the second valve body 22 by rotating the rotating shaft. The rotating shaft 30 is provided with a tip end part 31 having a rectangular cross section, which fixes the valve body 20 so as to be rotatable about the center axis A. The first valve body 21 and the second valve body 22 are in sliding contact with the inner wall part 11a of the main body part 11, and the rotational position is switched by rotating the rotating shaft 30, thereby switching the connection state of the plurality of ports 40.

As depicted in FIG. 1 and FIG. 2, a plurality of ports 40 (first port 41, second port 42, fifth port 45, third port 43, fourth port 44 and sixth port 46) are provided around the main body part 11 in a clockwise direction. These ports 40 have a cylindrical shape that protrudes around the periphery of the main body part 11 and penetrates to the side of the inner wall part 11a. The first port 41 and the second port 42 are provided at an interval of 90 degrees in the circumferential direction.

The third port 43 and the fourth port 44 are provided symmetrically around the center axis A with respect to the first port 41 and the second port 42, and are provided at an interval of 90 degrees in the circumferential direction. In other words, the third port 43 is provided at an interval of 90 degrees in the clockwise direction relative to the second port 42, and the fourth port 44 is provided at an interval of 90 degrees in the counterclockwise direction relative to the first port 41.

The fifth port 45 is provided between the second port 42 and the third port 43 at an interval of 45 degrees clockwise relative to the second port 42. The sixth port 46 is provided at an interval of 45 degrees in the counterclockwise direction relative to the first port 41.

Next, the configuration of the valve body 20 will be described with reference to FIG. 3 and FIG. 4.

As depicted in FIG. 3 and FIG. 4, the valve body 20 is composed of a first valve body 21, a second valve body 22, each of which has a generally semicircular shape, and a coil spring 25 acting as a biasing member.

The first valve body 21 is softer than the main body part 11, and is also softer than the rotating shaft 30. The first valve body 21 has a first seal part 21a that abuts against the inner wall part 11a of the housing 10, a first flow path 21b that is enclosed by the first seal part 21a and the inner wall part 11a to form a first space through which fluid flows, a support part 21c into which the tip end part 31 of the rotating shaft 30 is inserted, and a set of protruding parts 21d for positioning the center of the coil spring 25. The support part 21c has a first insertion hole 211 having a rectangular hole shape into which the tip end part 31 of the rotating shaft 30 is inserted.

As depicted in FIG. 4, the support part 21c has an axial cross section formed into a substantially U-shape, and a first insertion hole 211 is formed in each of an upper side part and a lower side part of the U-shape. The support part 21c is configured so that the support part 22c of the second valve body 22 is combined with the support part 21c from the open side of the U-shape.

The first insertion hole 211 has a comb-shaped part 21e on the outer side. The comb-shaped part 21e is configured with two convex parts that protrude from the outside to the inside of the first insertion hole 211, and these convex parts serve to determine the position when the tip end part 31 of the rotating shaft 30 is inserted into the first insertion hole 211.

The second valve body 22 is softer than the main body part 11, and also softer than the rotating shaft 30. The second valve body 22 has the same shape of the first valve body 21. In other words, the second valve body 22 has a second seal part 22a that abuts against the inner wall part 11a of the housing 10, a second flow path 22b that is enclosed by the second seal part 22a and the inner wall part 11a to form a second space through which fluid flows, a support part 22c into which is inserted the rectangular portion of the tip end of the rotating shaft 30 and which supports the rotating shaft 30, and a set of protruding parts 22d for positioning the center of the coil spring 25. The support part 22c has a second insertion hole 221 having a rectangular hole shape into which the tip end part 24 of the rotating shaft 30 is inserted.

The first valve body 21 and the second valve body 22 are flexible, so the degree of contact of the first valve body 21 and the second valve body 22 to the inner wall part 11a can be increased.

The support part 22c is formed in a shape that allows sandwiching between the U-shaped portion of the support part 21c of the first valve body 21, so the first valve body 21 and the second valve body 22 cannot move relative to each other in the longitudinal direction. When the first valve body 21 and the second valve body 22 are combined, the support part 22c of the second valve body 22 is sandwiched against the support part 21c of the first valve body 21, and the first insertion hole 211 of the first valve body 21 and the second insertion hole 221 of the second valve body 22 are configured as a single insertion hole 23. A tip end part 31 of a rotating shaft 30 is inserted into the insertion hole 23. The tip end part 31 of the rotating shaft 30 and the insertion hole 23 are configured so as to provide a gap between the two outer walls of the tip end part 31 and the two inner wall parts of the insertion hole 23 in the direction in which the first valve body 21 and the second valve body 22 face each other. Thereby, the support part 21c of the first valve body 21 and the support part 22c of the second valve body 22 are configured to be able to move relative to the tip end part 31 of the rotating shaft 30. Note that, in a direction perpendicular to the direction in which the first valve body 21 and the second valve body 22 face each other, the two inner walls of the insertion hole 23 are configured to be parallel and flush with each other in the direction of the center axis A, and the two outer walls of the tip end part 31 and the two outer walls of the insertion hole 23 abut without a gap.

A coil spring 25 formed of a wound spring is inserted between the protruding part 21d of the first valve body 21 and the protruding part 22d of the second valve body 22. The coil spring 25 biases the first valve body 21 and the second valve body 22 in a direction that presses against the inner wall part 11a of the housing 10. As a result, the first seal part 21a of the first valve body 21 and the second seal part 22a of the second valve body 22 are brought into close contact with the inner wall part 11a of the housing 10.

As described above, the support part 21c of the first valve body 21 and the support part 22c of the second valve body 22 are configured to be able to move relative to the tip end part 31 of the rotating shaft 30, so relative movement between the first valve body 21 and the second valve body 22 in the biasing direction is permitted while suppressing the load in the direction perpendicular to the rotating shaft 30, and the biasing force of the coil spring 25 causes the first seal part 21 a of the first valve body 21 and the second seal part 22a of the second valve body 22 to be in close contact with the inner wall part 11a of the housing 10.

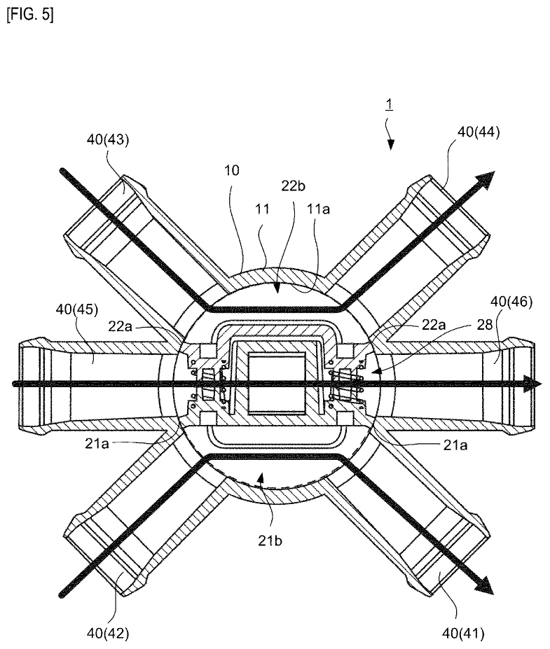

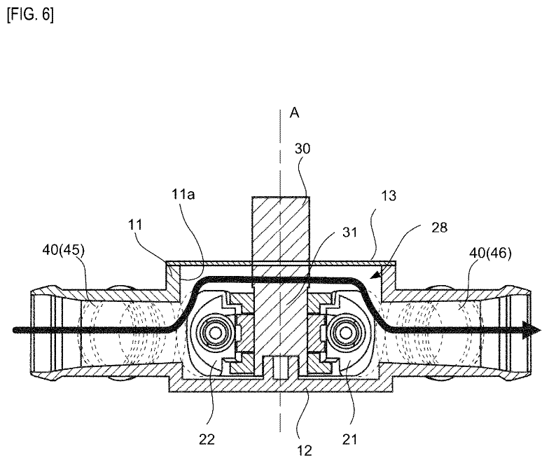

Next, the switching operation of the flow path switching valve 1 will be described with reference to FIG. 5 and FIG. 6.

FIG. 5 is a lateral cross-sectional view of the flow path switching valve 1 of the present embodiment, depicting a cross-sectional view along line V-V of FIG. 1. FIG. 6 is a longitudinal cross-sectional view of the flow path switching valve 1 of the present embodiment, depicting a cross-sectional view along line VI-VI of FIG. 1.

When the valve body 20 is in the position depicted in FIG. 5, the first flow path 21b enclosed by the first seal part 21a of the first valve body 21 and the inner wall part 11a of the housing 10 connects the first port 41 and the second port 42. Furthermore, a second flow path 22b enclosed by the second seal part 22a of the second valve body 22 and the inner wall part 11a of the housing 10 connects the third port 43 and the fourth port 44.

As depicted in FIG. 6, the periphery of the support part 21c of the first valve body 21 and the support part 22c of the second valve body 22 is spaced apart from the inner wall part 11a of the housing 10 and the cover part 13, and a third space connected with the fifth port 45 and the sixth port 46 is formed at this location. The third space is sealed relative to the second port 40 by the first seal part 21a and the second seal part 22a. The third space forms a third flow path 28 that connects the fifth port 45 and the sixth port 46.

In this manner, the flow paths between the first to sixth ports 41 to 46 are established by the valve body 20, and as depicted in FIG. 5, the first port 41 and the second port 42, the third port 43 and the fourth port 44, and the fifth port 45 and the sixth port 46 are connected to each other via the first flow path 21b, the second flow path 22b, and the third flow path 28, respectively. In other words, a first state is formed in which the first port 41 and the second port 42 are connected by the first flow path 21b of the first valve body 21, and the third port 43 and the fourth port 44 are connected by the second flow path 22b of the second valve body 22.

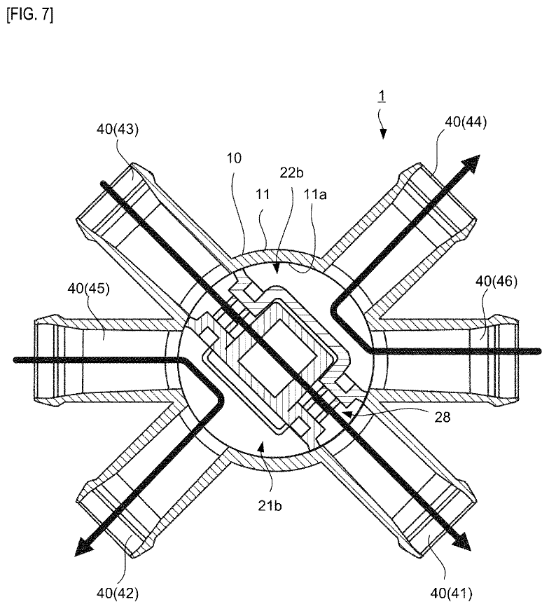

FIG. 7 is a lateral cross-sectional view of the flow path switching valve 1 of the present embodiment, depicting a state in which the valve body 20 is rotated 45 degrees clockwise with respect to FIG. 5.

When the valve body 20 is in the position depicted in FIG. 7, the first flow path 21b mutually connects the second port 42 and the fifth port 45. Furthermore, the second flow path 22b mutually connects the fourth port 44 and the sixth port 46. Furthermore, the third flow path 28 mutually connects the third port 43 and the first port 41.

In this manner, when the valve body 20 rotates to the position depicted in FIG. 7, the second port 42 and the fifth port 45, the fourth port 44 and the sixth port 46, and the third port 43 and the first port 41 are connected via the first flow path 21b, the second flow path 22b, and the third flow path 28, respectively.

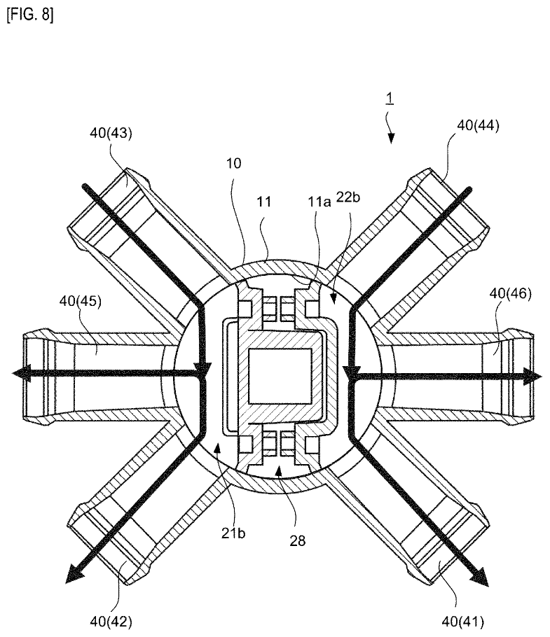

FIG. 8 is a lateral cross-sectional view of the flow path switching valve 1 of the present embodiment, depicting a state in which the valve body 20 is rotated 90 degrees clockwise with respect to FIG. 5.

When the valve body 20 is in the position depicted in FIG. 7, the first flow path 21b mutually connects the second port 42, the fifth port 45, and the third port 43. Furthermore, the second flow path 22b connects the fourth port 44, the sixth port 46, and the first port 41. In this case, none of the ports 40 are open at a position corresponding to the third flow path 28.

In this manner, when the valve body 20 rotates to the position depicted in FIG. 8, the third port 43, the fifth port 45, and the second port 42, as well as the fourth port 44, the sixth port 46, and the first port 41 are mutually connected via the first flow path 21b and the second flow path 22b, respectively. In other words, a second state is formed in which the first port 41 and the second port 42 are not connected by the first flow path 21b of the first valve body 21, and the third port 43 and the fourth port 44 are not connected by the second flow path 22b of the second valve body 22.

In this manner, the rotation of the rotating shaft 30 causes the valve body 20 to rotate around the center axis A of the housing 10, thereby switching the flow paths between the first to sixth ports 41 to 46 provided in the housing 10.

Note that in the present embodiment, a configuration has been described in which a set of a first valve body 21 and a second valve body 22 provided symmetrically around the center axis A of the housing 10 each have a first flow path 21b and a second flow path 22b, respectively. However, this is not a limitation, and for example, one valve body 20 may be configured to close all of the ports 40 located in the opposing inner wall part 11a. In other words, the second valve body 22 may not have a second flow path 22b, and a configuration is possible where the entire area enclosed by the second seal part 22a is in contact with the inner wall part 11a of the housing 10, and this portion may close the port 40.

When configured in this manner, for example, in FIG. 5, when the first valve body 21 connects the first port 41 and the second port 42 via the first flow path 21b, the second valve body 22 is in a state in which the third port 43 and the fourth port 44 are closed, respectively. Even with this configuration, the biasing force of the coil spring 25 causes locations that face the inner wall part 11a of the second seal part 22 and the first seal part 21a of the first valve body to be in close contact with the inner wall part 11a of the housing 10.

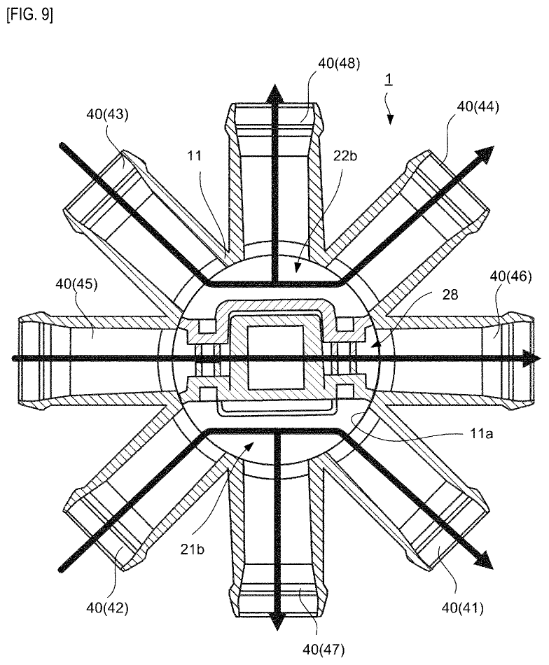

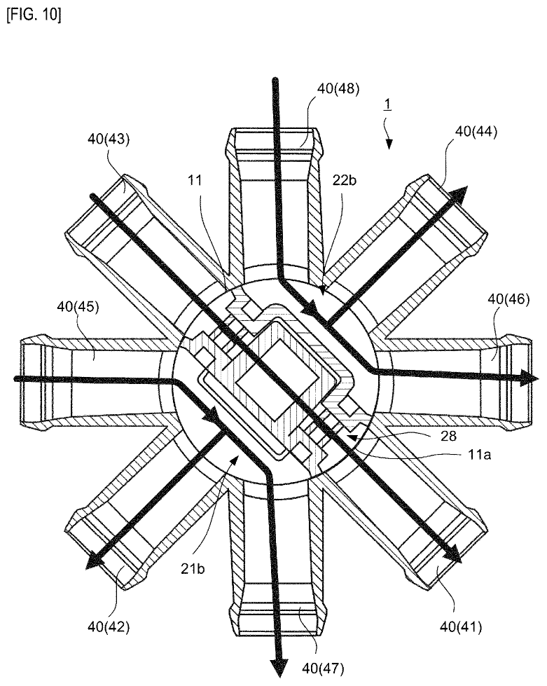

Next, a modified example of the present embodiment will be described with reference to FIG. 9 and FIG. 10.

FIG. 9 and FIG. 10 depict a lateral cross-sectional view of a flow path switching valve 1 according to a modified example of the present embodiment.

The modified example of FIG. 9 and FIG. 10 depicts, in addition to the embodiment described in reference to FIG. 5, that the port 40 further includes a seventh port 47 and an eighth port 48.

The seventh port 47 is provided between the first port 41 and the second port 42, and is provided at a position 45 degrees clockwise relative to the first port 41. The eighth port 48 is provided between the third port 43 and the fourth port 44, and is provided at a position 45 degrees clockwise relative to the third port 43. Therefore, in the configuration depicted in FIG. 9, the eight ports 40, namely first to eighth ports 41 to 48, are provided at equal intervals of 45 degrees. The other configuration is similar to the configuration of FIG. 5.

In this configuration as well, the valve body 20 is rotated about the center axis A of the housing 10 by rotating the rotating shaft 30, whereby the connection state of each port 40 is switched.

When the valve body 20 is in the position depicted in FIG. 9, the first flow path 21b connects the first port 41, the seventh port 47, and the second port 42. Furthermore, the second flow path 22b connects the third port 43, the eighth port 48 and the fourth port 44. Furthermore, the third flow path 28 connects the fifth port 45 and the sixth port 46 to each other.

FIG. 10 depicts a state in which the valve body 20 has been rotated 45 degrees clockwise with respect to FIG. 9.

When the valve body 20 is in the position depicted in FIG. 10, the first flow path 21b connects the seventh port 47, the second port 42, and the fifth port 45. Furthermore, the second flow path 22b connects the eighth port 48, the fourth port 44, and the sixth port 46. Furthermore, the third flow path 28 mutually connects the third port 43 and the first port 41.

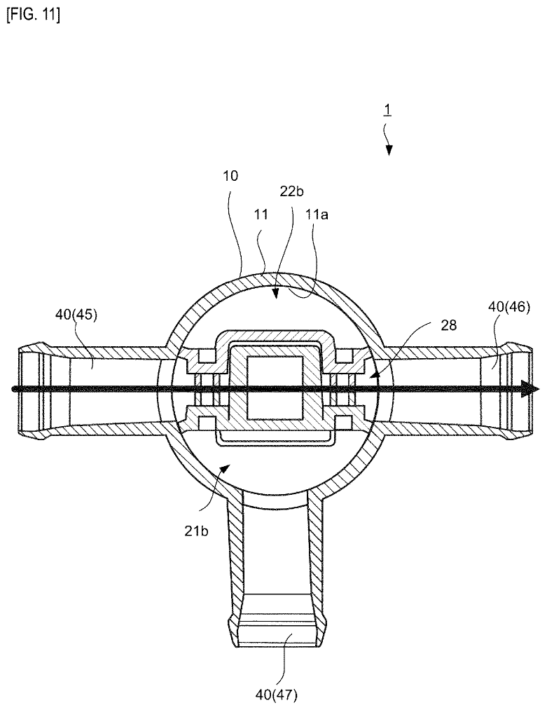

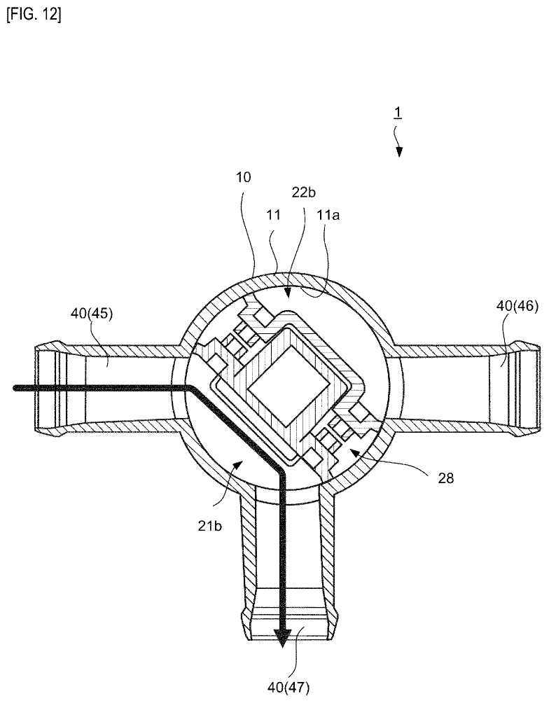

Next, another modified example of the present embodiment will be described with reference to FIG. 11 and FIG. 12.

FIG. 11 and FIG. 12 are lateral cross-sectional views of a flow path switching valve 1 according to another modified example of the present embodiment.

The modified example described in reference to FIG. 11 and FIG. 12 depicts an example in which only three ports 40 are provided in comparison with the embodiment described above with reference to FIG. 5.

As depicted in FIG. 11, a sixth port 46, a seventh port 47, and a fifth port 45 are provided around the main body part 11 in a clockwise direction. The fifth port 45 and the sixth port 46 are provided to be 180 degrees apart (in a straight line) about the center axis A. The seventh port 47 is provided at a position that is 45 degrees clockwise relative to the sixth port 46 and at a position that is 45 degrees counterclockwise relative to the fifth port 45 around the center axis A.

In this configuration as well, the valve body 20 is rotated about the center axis A of the housing 10 by rotating the rotating shaft 30, whereby the connection state of each port 40 is switched.

When the valve body 20 is in the position depicted in FIG. 11, the third flow path 28 connects between the fifth port 45 and the sixth port 46. Only the seventh port 47 is present at a position corresponding to the first flow path 21b, and no flow path is formed connecting the plurality of ports 40. There is no port 40 at a position corresponding to the second flow path 22b.

FIG. 12 depicts a state in which the valve body 20 has been rotated 45 degrees clockwise with respect to FIG. 11.

When the valve body 20 is in the position depicted in FIG. 12, the first flow path 21b mutually connects the fifth port 45 and the seventh port 47. Furthermore, the second flow path 22b connects with the sixth port 46, but does not connect with the other ports 40, and therefore the sixth port 46 is in a closed state. The port 40 does not exist at a position corresponding to the third flow path 28, so no flow path is formed connecting with the port 40.

In this manner, even if the position and location of the port 40 provided around the housing 10 is changed, the connection state (or closed state) of the port 40 can be changed by changing the rotational position of the valve body 20.

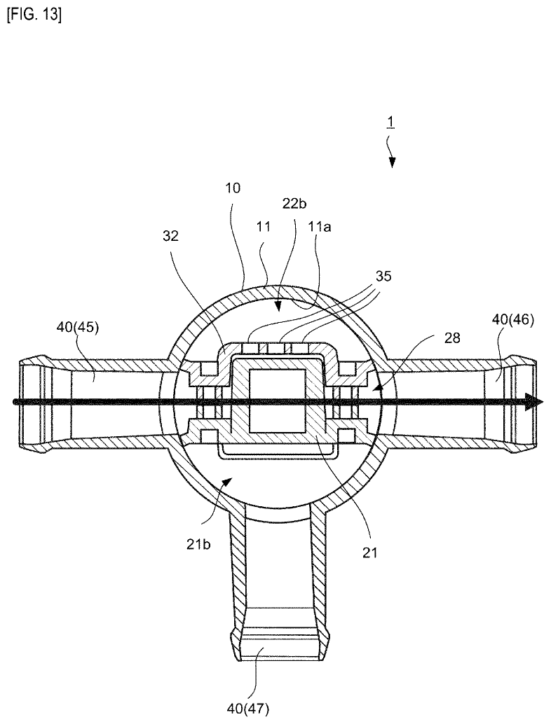

Next, yet another modified example of the present embodiment will be described with reference to FIG. 13 to FIG. 16.

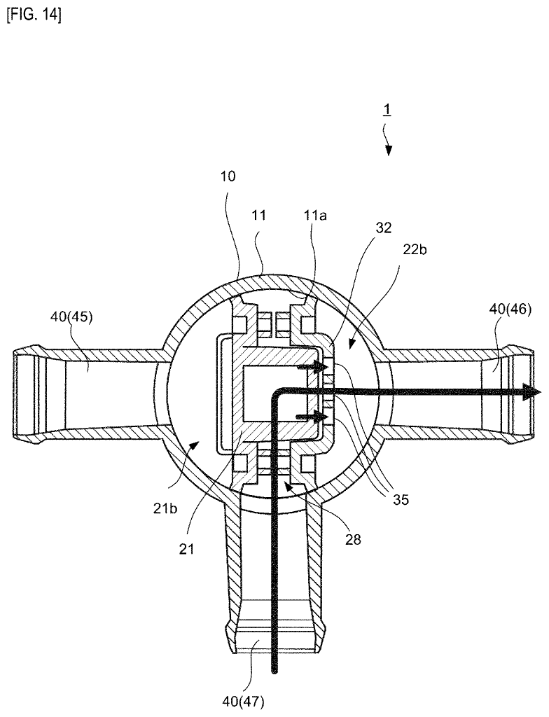

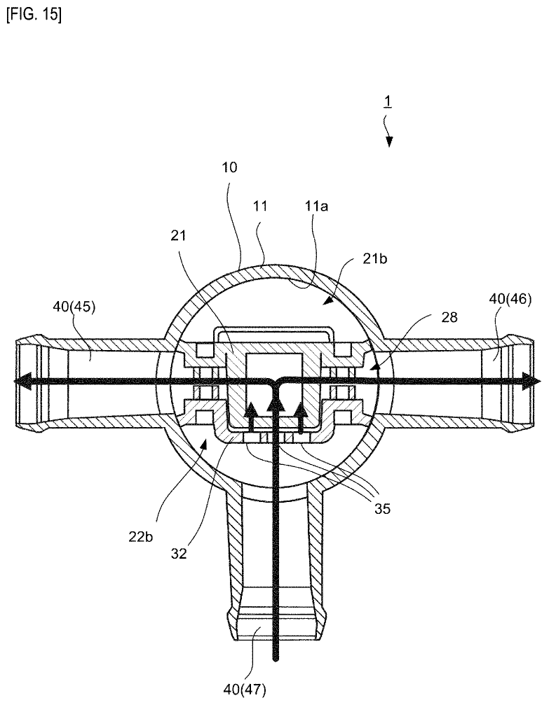

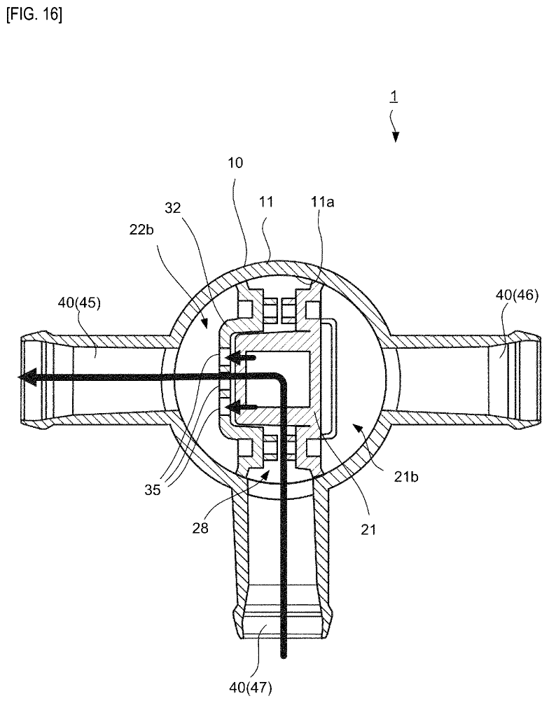

FIG. 13, FIG. 14, FIG. 15, and FIG. 16 are lateral cross-sectional views of a flow path switching valve 1 according to yet another modified example of the present embodiment.

In the modified examples described in reference to FIG. 13 to FIG. 16, the configuration of the second valve body 22 is different from that of the embodiment described above with reference to FIG. 11.

As depicted in FIG. 13, the second valve body 22 has a second flow path 22b formed between the second valve body 22 and the inner wall part 11a of the housing 10, and a connecting hole 35 that mutually connects with a third flow path 28 formed between the first valve body 21, the second valve body 22, and the inner wall part 11a. The connecting hole 35 keeps the second flow path 22b and the third flow path 28 in a constant state of mutual connection. In other words, the second valve body 22 does not function as a valve that switches the connection state of a plurality of ports.

In the modified example configured in this manner, when the valve body 20 is in the position depicted in FIG. 13, the third flow path 28 connects the fifth port 45 and the sixth port 46. Only the seventh port 47 is present at a position corresponding to the first flow path 21b, and no flow path is formed connecting the plurality of ports 40. No port 40 is present at a position corresponding to the second flow path 22b, so no flow path is formed connecting between the plurality of ports 40.

FIG. 14 depicts a state in which the valve body 20 has been rotated 90 degrees clockwise with respect to FIG. 13.

When the valve body 20 is in the position depicted in FIG. 14, the third flow path 28 and the second flow path 22b are connected by the connecting hole 35, and therefore the seventh port 47 and the sixth port 46 are connected at positions corresponding to these flow paths. Only the fifth port 45 is present at a position corresponding to the first flow path 21b, and no flow path is formed connecting the plurality of ports 40.

FIG. 15 depicts a state in which the valve body 20 has also been rotated 90 degrees clockwise with respect to FIG. 14.

When the valve body 20 is in the position depicted in FIG. 15, the third flow path 28 and the second flow path 22b are connected by the connecting hole 35, and therefore the fifth port 45, the seventh port 47, and the sixth port 46 are mutually connected at positions corresponding to these flow paths. No port 40 is present at a position corresponding to the first flow path 21b, so no flow path is formed connecting between the plurality of ports 40.

FIG. 16 depicts a state in which the valve body 20 has also been rotated 90 degrees clockwise with respect to FIG. 15.

When the valve body 20 is in the position depicted in FIG. 16, the third flow path 28 and the second flow path 22b are connected by the connecting hole 35, and therefore the seventh port 47 and the fifth port 45 are connected at positions corresponding to these flow paths. Only the sixth port 46 is present at a position corresponding to the first flow path 21b, and no flow path is formed connecting the plurality of ports 40.

In this manner, either the first valve body 21 or the second valve body 22 can be configured so as to not function as a valve for switching the connection state of a plurality of ports. Even with this configuration, the first valve body 21 and the second valve body 22 can be configured to be in mutual close contact against the inner wall part 11a of the housing 10 by the biasing force of the coil spring 25.

The following effects are achieved by the aforementioned first embodiment.

In the present embodiment, a flow path switching valve 1, includes:
a housing 10 including a main body part 11 having a cylindrical inner wall part 11a and a plurality of ports 40 opening in a circumferential direction, a bottom part 12 covering a first end of the main body part 11 in a center axis A direction, and a cover part 13 covering a second end of the main body part 11 in the center axis A direction;
a valve body 20 stored inside the housing 10 so as to be rotatable about the center axis A, the valve body 20 including a set of a first valve body 21 and a second valve body 22 positioned around the center axis A, the valve body 20 being in sliding contact with the inner wall part 11a to switch connection state between the plurality of ports 40;
a rotating shaft 30 extending in the center axis A direction, connecting the first valve body 21 and the second valve body 22 so as to be movable in a radial direction, and switching rotational position of the first valve body 21 and the second valve body 22 by rotating the rotating shaft 30; and
a coil spring 25 that biases the first valve body 21 and the second valve body 22 toward the inner wall part 11a.

With this configuration, the first valve body 21 and the second valve body 22 that constitute the valve body 20 are provided around the center axis A and are biased toward the inner wall part 11a by the coil spring 25, so a load in the bending direction can be prevented from being generated on the rotating shaft 30, and the biasing force can improve the sealing performance between the first valve body 21 and the second valve body 22.

In addition, in the present embodiment, the first valve body 21 and the second valve body 22 are provided in opposing positions around the center axis A and are movable in opposing directions, and the coil spring 25 is provided between the first valve body 21 and the second valve body 22, and mutually biases the first valve body 21 and the second valve body 22 toward the corresponding inner wall part 11a.

With this configuration, the first valve body 21 and the second valve body 22 that constitute the valve body 20 are provided symmetrically around the center axis A and are mutually biased toward the inner wall part 11a by the coil spring 25, so a load in the bending direction can be prevented from being generated on the rotating shaft 30, and the biasing force can improve the sealing performance between the first valve body 21 and the second valve body 22.

In addition, in the present embodiment, the first valve body 21 and the second valve body 22 each have an insertion hole 23 into which the rotating shaft 30 is inserted, and when the rotating shaft 30 is inserted into the insertion hole 23, a gap in the opposing direction is provided between the tip end part 31 of the rotating shaft 30 and the insertion hole 23, and in a direction perpendicular to the direction in which the first valve body 21 and the second valve body 22 oppose each other, the tip end part 31 of the rotating shaft 30 abuts against the insertion hole 23 without a gap. Therefore, relative movement between the first valve body 21 and the second valve body 22 in the biasing direction is permitted while suppressing the load in the direction perpendicular to the rotating shaft 30, and the first valve body 21 and the second valve body 22 are in close contact to the inner wall part 11a of the housing 10 due to the biasing force of the coil spring 25.

Furthermore, in the present embodiment, the inside of the housing 10 is divided into a first space enclosed by the first valve body 21 and the inner wall part 11a, a second space enclosed by the second valve body 22 and the inner wall part 11a, and a third space enclosed by the first valve body 21, the second valve body 22, and the inner wall part 11a. Therefore, depending on the rotational position of the valve body 20, the plurality of ports 40 opening into the housing 10 can be connected to the first space, second space, and third space, thereby changing the connection state (or closed state) of the plurality of ports 40.

In addition, in the present embodiment, the first valve body 21 has a first seal part 21a, the first space is enclosed by the first seal part 21a and the inner wall part 11 a to form a first flow path 21b, which is a space through which a fluid flows, and the first valve body has a first insertion hole 211 into which the rotating shaft 30 is inserted. Furthermore, the ports 40 include a first port 41 and a second port 42 provided at a prescribed angle around the center axis A, and the first valve body 21 is switched between a first state where the first port 41 and the second port 42 are connected by the first flow path 21b, and a second state where the first port 41 and the second port 42 are not connected.

With this configuration, the flow path switching valve 1 is configured such that the valve body 20 is rotated by rotating the rotating shaft 30, thereby switching the connection state between the first port 41 and the second port 42.

In addition, in the present embodiment, the second valve body 22 has a second seal part 22a, the second space is enclosed by the second seal part 22a and the inner wall part 11a to form a second flow path 22b, which is a space through which a fluid flows, and the second valve body has a second insertion hole 221 into which the rotating shaft 30 passes through. Furthermore, the ports 40 further include a first port 41 and a second port 42 provided symmetrically around the center axis A, and also include a third port 43 and a fourth port 44 provided at a predetermined angle from each other around the center axis A, where in a first state, the second valve body 22 connects the third port 43 and the fourth port 44 by the second flow path 22b, but in a second state, the second valve body 22 does not connect the third port 43 and the fourth port 44.

With this configuration, the flow path switching valve 1 is configured such that the valve body 20 is rotated by rotating the rotating shaft 30, thereby switching the connection state between the third port 43 and the fourth port 44.

In addition, in the present embodiment, the third space forms a third flow path 28 through which fluid flows between the first valve body 21 and the second valve body 22, and the ports 40 further include a fifth port 45 provided between the first port 41 and the third port 43, and a sixth port 46 provided between the second port 42 and the fourth port 44, and a third flow path 28 connects the fifth port 45 and the sixth port 46.

With this configuration, the flow path switching valve 1 is configured such that the valve body 20 is rotated by rotating the rotating shaft 30, thereby also switching the connection state between the fifth port 45 and the sixth port 46.

### Second Embodiment

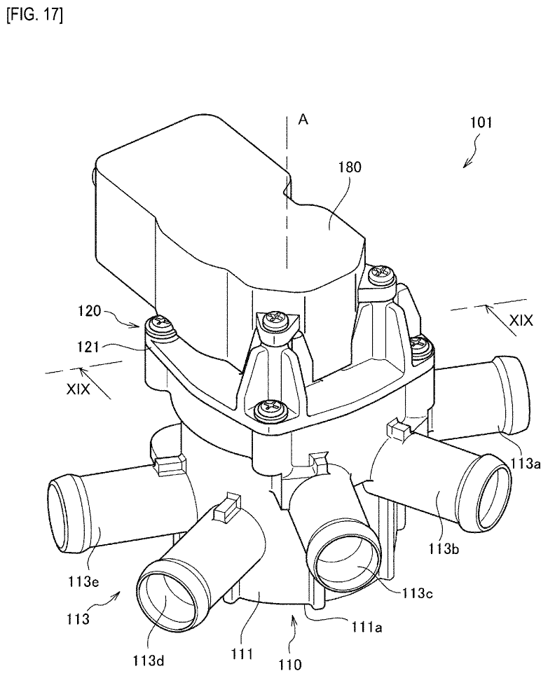

Hereinafter, a flow path switching valve 101 according to a second embodiment of the present invention will be described with reference to FIG. 17 to FIG. 33. In each of the embodiments described below, primarily the differences from the aforementioned flow path switching valve 1 will be described, and components having similar functions will be assigned the same reference numerals, and descriptions thereof are omitted.

First, the overall configuration of a flow path switching valve 101 will be described with reference to FIG. 17 to FIG. 20.

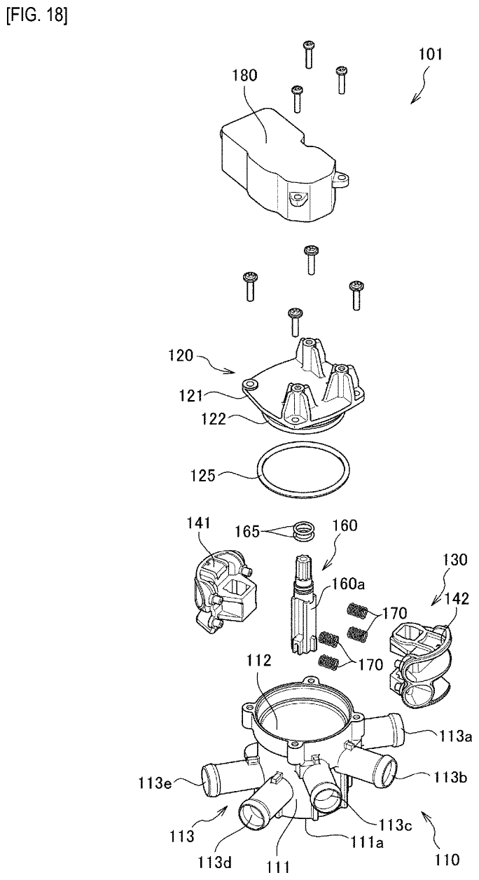

FIG. 17 is a perspective view of the flow path switching valve 101. FIG. 18 is an exploded perspective view of FIG. 17. FIG. 19 is a cross-sectional view along line XIX-XIX in FIG. 17. FIG. 20 is a plan view of the flow path switching valve 101, depicting a state in which the cover part 120 has been removed from the main body part 111 of the housing 110.

In the following, the direction along the center axis A of the housing 110 (center axis of rotation of the valve body 130) will be referred to as the “center axis direction (center axis A direction)”, the direction from the center axis A of the housing 110 toward the outer diameter will be referred to as the “radial direction”, and the direction in which the valve body 130 rotates in the housing 110 will be referred to as the “rotational direction”.

As depicted in FIG. 17 to FIG. 19, the flow path switching valve 101 includes a housing 110, a valve body 130, and an actuator 180.

The housing 110 has a main body part 111 and a cover part 120.

As depicted in FIG. 18, the main body part 111 is formed in a generally cylindrical shape with a bottom. The main body part 111 has a bottom part 111a, an inner wall part 112, a plurality of ports 113, and a connecting part 115 serving as a third flow path.

The bottom part 111a covers a first end of the main body part 111 in the direction of the center axis A.

The inner wall part 112 is an inner peripheral surface of a substantially bottomed cylindrical shape. The inner wall part 112 is formed with a smooth curved surface so that the valve body 130 can slide in contact. A plurality of ports 113 are formed in the inner wall part 112.

As depicted in FIG. 17 and FIG. 18, the ports 113 connect between the inner periphery and the outer periphery of the main body part 111. The ports 113 are provided in a plurality of rows in the direction of the center axis A, and in the circumferential direction of the housing 110. The ports 113 include a first port 113a, a second port 113b, a third port 113c, a fourth port 113d, and a fifth port 113e.

The first port 113a, the second port 113b, and the third port 113c are provided at the same positions in the direction of the center axis A and aligned in order in the circumferential direction. The first port 113a, the second port 113b, and the third port 113c constitute a first layer L1 as a first stage (see FIG. 19). The first port 113a, the second port 113b, and the third port 113c are provided radially at prescribed angular intervals in the circumferential direction.

The fourth port 113d and the fifth port 113e are provided at the same position in the direction of the center axis A and are provided aligned in order in the circumferential direction. The fourth port 113d and the fifth port 113e are provided at positions in the direction of the center axis A closer to the bottom part 111a than the first layer L1. The fourth port 113d and the fifth port 113e constitute a second layer L2 as a second stage (see FIG. 19).

In other words, the plurality of ports 113 are provided in two layers, a first layer L1 and a second layer L2, in the direction of the center axis A. In addition, a third layer (not depicted), a fourth layer (not depicted), and the like may be further provided side by side. In other words, the ports 113 are provided in two or more rows in the direction of the center axis A of the housing 110.

Note that as depicted in FIG. 20, in a plan view, the first port 113a, the second port 113b, the third port 113c, the fourth port 113d, and the fifth port 113e are provided at equal intervals (here, 45° intervals) in the circumferential direction (clockwise direction).

As depicted in FIG. 19, the connecting part 115 connects, in the direction of the center axis A, spaces between the first valve body 141 and the second valve body 142 (described later) that are provided side by side in the direction of the center axis A. The connecting part 115 guides the fluid flowing in from the port 113 not enclosed by the valve body 130 to another port 113 through gaps between the rotating shaft 160, the coil spring 170, and the like inside the housing 110.

As depicted in FIG. 20, the housing 10 has a plurality of slits 116 serving as sliding resistance reducing parts.

The slits 116 are provided in the inner wall part 112 of the housing 110 and extend in the direction of the center axis A. The slits 116 are located opposite the inner wall part 112 where the port 113 is formed, sandwiching the rotating shaft 160, and reduce the contact area between the seal part described later and the valve body 130 on the inner wall part 112 at other positions where the port 113 is not formed, thereby reducing the sliding resistance. Thereby, the drive torque of the actuator 180 can be reduced, enabling use of a small actuator 180. Therefore, the entire flow path switching valve 101 can be made compact.

The slits 116 are formed so as to connect adjacent slits 116 in the circumferential direction with a continuous smooth curved surface. A contact surface 116a is formed between adjacent slits 116.

The contact surface 116a is a curved surface formed with the same curvature as the inner wall part 112, and constitutes a portion of the inner wall part 112. By providing the contact surface 116a, the seal part of the valve body 130 and the contact surface 116a are in surface contact rather than line contact, so as to disperse the force acting on the valve body 130 when the seal part of the valve body 130 is pressed against the inner wall part 112.

Note that the slits 116 may be provided in the inner wall part 11a of the main body part 11 in the housing 10 of the first embodiment.

As depicted in FIG. 17 to FIG. 19, the cover part 120 closes the second end of the main body part 111 in the direction of the center axis A. The cover part 120 has an end plate part 121 and a cylindrical part 122.

The end plate part 121 is formed in a flat plate shape, and closes the second end of the main body part 111 in the direction of the center axis A.

As depicted in FIG. 18, the cylindrical part 122 is formed in a cylindrical shape with one end fixed to the end plate part 121. A circular seal member 125 serving as a sealing member is provided on the outer periphery of the cylindrical part 122. The cylindrical part 122 seals the inside and outside of the housing 110 by sandwiching and securing the seal member 125 between the cylindrical part 122 and the main body part 111. An annular flow path 123 is formed between the inner periphery of the cylindrical part 122 and the side surface of the valve body 130.

The annular flow path 123 is provided on the outer periphery of a portion where a shaft seal 165 that seals the outer periphery of the rotating shaft 160 is provided. In other words, the space required for providing the shaft seal 165 is utilized, so the housing 110 does not become larger due to providing the annular flow path 123.

For example, when a fluid that flows into the connecting part 115 from a port 113 in the first layer L1 flows out from another port 113 in the second layer L2, the annular flow path 123 guides the fluid not only to the connecting part 115 at a position close to the port 113 into which the fluid flows, but also to the connecting part 115 at a position away from the port 113 into which the fluid flows. Thus, by providing the annular flow path 123, the fluid can be guided to portions where the flow resistance of the fluid is high and the fluid is difficult to guide due to the rotating shaft 160, the coil spring 170, and the like. Therefore, the flow of the fluid can be dispersed so that the fluid can flow through all of the gaps in the housing 110. Therefore, the flow resistance of the fluid can be reduced.

As depicted in FIG. 18 to FIG. 20, the valve body 130 is accommodated inside the housing 110 so as to be rotatable around the rotating shaft 160. The valve body 130 is capable of being displaced in the radial direction relative to the rotating shaft 160. The valve body 130 has a rotating shaft 160 and a plurality of coil springs 170 serving as biasing members.

The valve body 130 switches the connection state of the plurality of ports 113. The valve body 130 is provided across the first layer L1 and the second layer L2. The valve body 130 includes a first valve body 141 and a second valve body 142. The first valve body 141 and the second valve body 142 are movable in the radial direction relative to the center axis A of the housing 110, and are biased toward the inner circumferential surface of the housing 110 by a coil spring 170 which will be described later.

The first valve body 141 is formed in a generally semicircular shape. The first valve body 141 is softer than the main body part 11, and also softer than the rotating shaft 160. The first valve body 141 is formed to be larger in the direction of the center axis A so as to span the first layer L1 and the second layer L2. The first valve body 141 is formed asymmetrically in at least one of the direction of the center axis A and the circumferential direction.

The second valve body 142 is formed in a generally semicircular shape. The second valve body 142 is softer than the main body part 11, and also softer than the rotating shaft 160. The second valve body 142 is provided opposite to the first valve body 141 sandwiching the center axis A of the housing 110. The second valve body 142 is formed to be larger in the direction of the center axis A so as to span the first layer L1 and the second layer L2. The second valve body 142 is formed asymmetrically in at least one of the direction of the center axis A and the circumferential direction.

Thus, the valve body 130 includes the first valve body 141 and the second valve body 142 provided in opposing positions centered around the rotating shaft 160. At least one of the first valve body 141 and the second valve body 142 is provided so as to connect with each of the plurality of ports 113 that are provided at different positions (different layers) in the direction of the center axis A among the plurality of ports 113.

As depicted in FIG. 18 and FIG. 19, the rotating shaft 160 extends in the direction of the center axis A of the housing 110. The rotating shaft 160 connects the first valve body 141 and the second valve body 142 so as to be movable in opposing directions. Rotating the rotating shaft 160 switches the rotational positions of the first valve body 141 and the second valve body 142.

As depicted in FIG. 18 and FIG. 20, the coil spring 170 is provided between the first valve body 141 and the second valve body 142. The coil spring 170 biases both the first valve body 141 and the second valve body 142 toward the inner wall part 112 where the port 113 is formed.

The plurality of coil springs 170 provided between the first valve body 141 and the second valve body 142 are provided at two locations separated in the direction of the center axis A. The center axes of the plurality of coil springs 170 are provided such that the position in the direction of the center axis A matches a center axis of the port 113.

The actuator 180 operates upon receiving a command signal from a controller (not depicted). The actuator 180 is connected to the rotating shaft 160 and drives the rotating shaft 160 to rotate.

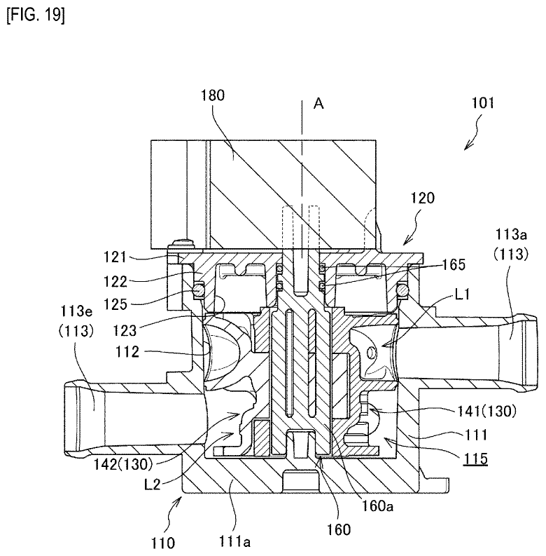

Next, specific configurations of the first valve body 141 and the second valve body 142 of the valve body 130 will be described with reference to FIG. 21 to FIG. 25B.

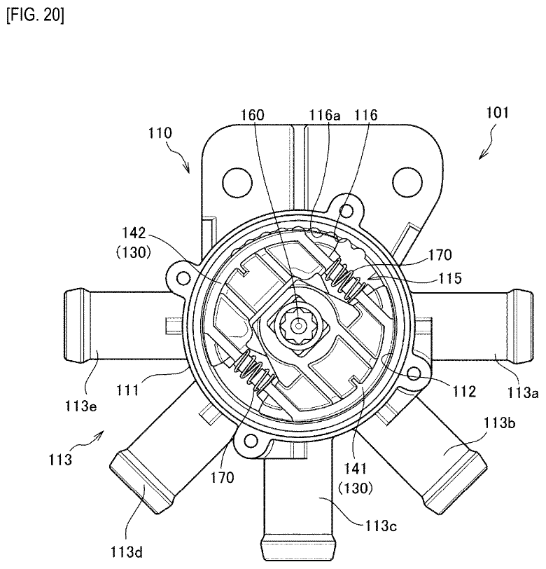

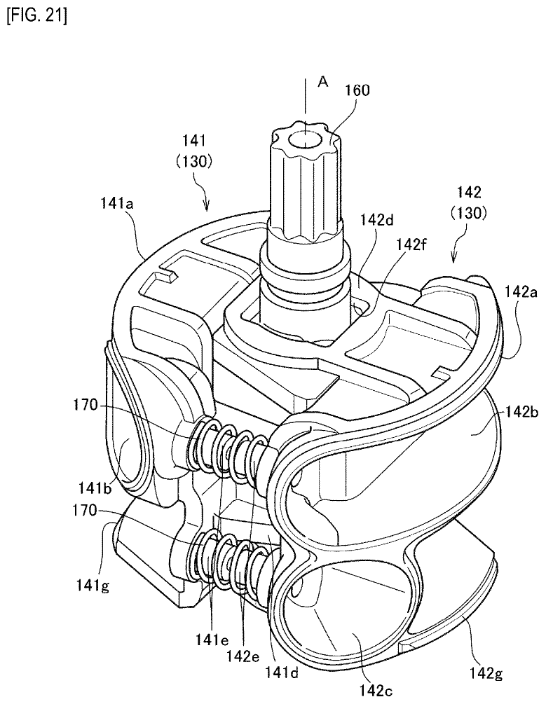

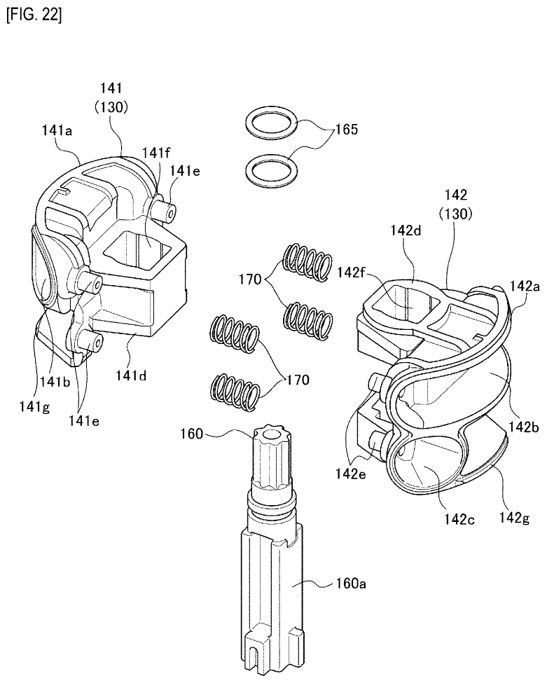

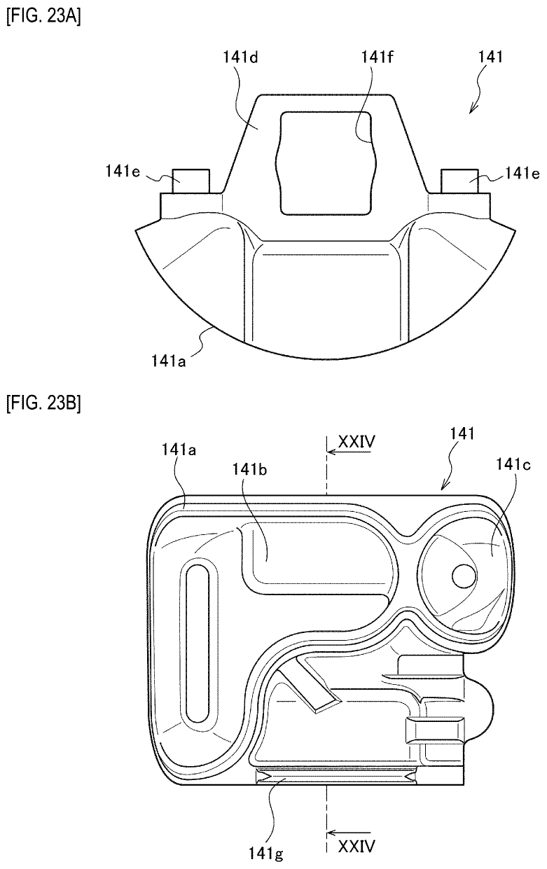

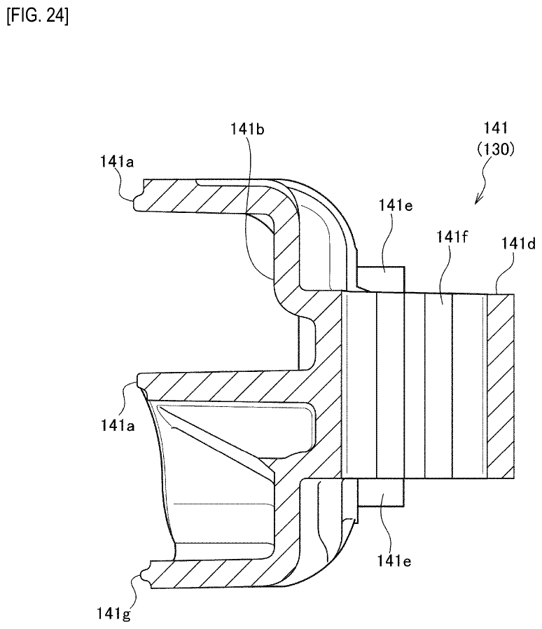

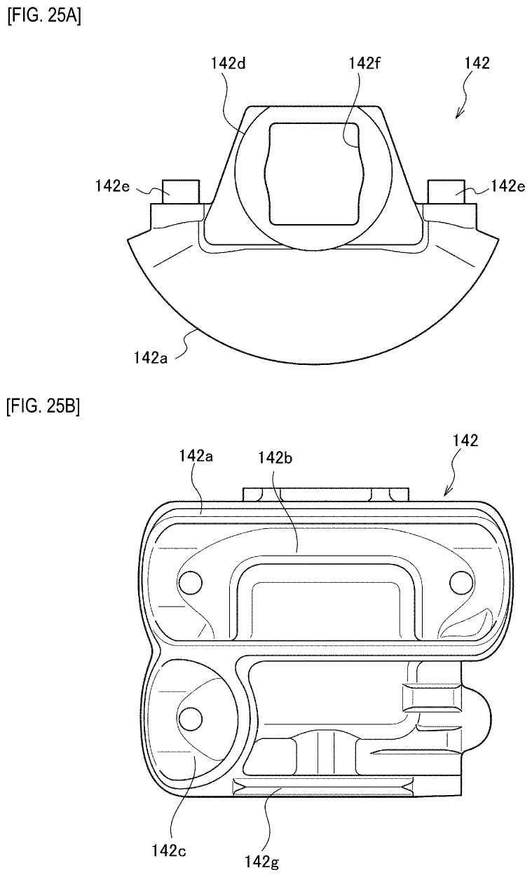

FIG. 21 is a perspective view of the valve body 130, the rotating shaft 160, and the coil spring 170 in an assembled state. FIG. 22 is an exploded perspective view of FIG. 21. FIG. 23A is a plan view of the first valve body 141. FIG. 23B is a front view of the first valve body 141. FIG. 24 is a cross-sectional view along line XXIV-XXIV in FIG. 23B. FIG. 25A is a plan view of the second valve body 142. FIG. 25B is a front view of the second valve body 142.

As depicted in FIG. 21 to FIG. 23B, the first valve body 141 has a first seal part 141a, a first flow path 141b, a first sealing part 141c, a support part 141d, a plurality of (herein, four) protruding parts 141e, and a sliding part 141g.

The first seal part 141a abuts against the inner wall part 112 of the housing 110. The first seal part 141a is formed as a curved surface having the same curvature as the inner wall part 112.

As depicted in FIG. 24, of the edge part of the first seal part 141a that faces the inner wall part 112 where the port 113 is formed, only a portion of the inner circumferential side in the thickness direction abuts against the inner wall part 112 of the housing 110 to form a seal surface. Specifically, the first seal part 141a is formed so as to have a thickness that is half or less of the thickness of the edge part that faces the inner wall part 112.

This reduces the contact area between the first seal part 141a and the inner wall part 112, thereby reducing the sliding resistance. Therefore, the driving torque by the actuator 180 can be reduced. In addition, when a fluid flows into the first flow path 141b and the pressure increases, even if the free end part of the first seal part 141a deforms toward the outer periphery, the contact state between the first seal part 141a and the inner wall part 112 can be maintained. Therefore, the sealing performance of the first seal part 141a can be maintained.

Note that the structure of the first seal part 141a depicted in FIG. 24 is also applied to the second valve body 142 of the valve body 130 and the valve body 20 of the first embodiment. Thereby, the drive torque of the actuator 180 can be reduced, enabling use of a small actuator 180. Therefore, the entire flow path switching valve 101 can be made compact. Note that in the present embodiment, the seal surface is formed integrally with the valve body 130, but the seal surface may be formed from a different material or member so as to be freely deformable.

As depicted in FIG. 21 to FIG. 23B, the first flow path 141b is enclosed by the first seal part 141a and the inner wall part 112 to form a first space through which the fluid flows. The first flow path 141b is formed spanning across the first layer L1 and the second layer L2. The first flow path 141b is formed in a substantially L-shape so as to be able to connect two ports 113 provided in the first layer L1 with one port 113 provided in the second layer L2.

The first sealing part 141c is enclosed by the first seal part 141a and the inner wall part 112 so as to stop the flow of fluid. The first sealing part 141c is capable of stopping the flow of fluid through one of the ports 113 provided in the first layer L1, the port 113 being adjacent to the port 113 connected by the first flow path 141b.

A rectangular part 160a of a rotating shaft 160 is fitted into the support part 141d. The support part 141d has a first insertion hole 141f having a rectangular hole shape into which the rectangular part 160a of the rotating shaft 160 is inserted.

The support part 141d is configured to be formed in a shape that allows sandwiching between the U-shaped portion of the support part 142d of the second valve body 142, so the first valve body 141 and the second valve body 142 cannot move relative to each other in the longitudinal direction. When the first valve body 141 and the second valve body 142 are combined, the support part 142d of the second valve body 142 is sandwiched between the support part 141d of the first valve body 141, and the first insertion hole 141f of the first valve body 141 and the second insertion hole 142f of the second valve body 142 are configured as a single insertion hole. The rectangular part 160a of the rotating shaft 160 is inserted into this insertion hole.

The protruding part 141e faces a protruding part 142e of the second valve body 142 with a gap therebetween. The protruding part 141e determines the position of the center of the coil spring 170. The coil spring 170 is attached to the protruding part 141e.

The sliding part 141g is provided outside the first flow path 141b so as to be aligned with a portion of the first flow path 141b in the direction of the center axis A, and slides against the inner wall part 112. The sliding part 141g is a protrusion that extends in the circumferential direction and does not itself form a flow path. As a result, when the first valve body 141 is formed asymmetrically in at least one of the direction of the center axis A and the circumferential direction, the sliding part 141g slides against the inner wall part 112, thereby preventing the position of the first valve body 141 from shifting or tilting.

As depicted in FIG. 21 to FIG. 22 and FIG. 25A to FIG. 25B, the second valve body 142 has a second seal part 142a, a second flow path 142b, a second sealing part 142c, a support part 142d, a plurality of (herein, four) protruding parts 142e, and a sliding part 142g.

The second seal part 142a abuts against the inner wall part 112 of the housing 110. The second seal part 142a is formed as a curved surface having the same curvature as the inner wall part 112.

The second flow path 142b is enclosed by the second seal part 142a and the inner wall part 112 to form a second space through which the fluid flows. The second flow path 142b is formed in the first layer L1. The second flow path 142b is formed in a substantially straight line so as to be able to connect with the three ports 113 provided in the first layer L1.

The second sealing part 142c is enclosed by the second seal part 142a and the inner wall part 112 to stop the flow of fluid. The second sealing part 142c is capable of stopping the flow of fluid through the port 113 at one end of the plurality of ports 113 provided in the second layer L2 and connected by the second flow path 142b, and through the port 113 adjacent thereto in the direction of the center axis A.

A rectangular part 160a of a rotating shaft 160 is fitted into the support part 142d. The support part 142d has a second insertion hole 142f having a rectangular hole shape into which the rectangular part 160a of the rotating shaft 160 is inserted.

The rectangular part 160a of the rotating shaft 160 and the insertion hole are configured so that gaps are formed between the two outer walls of the rectangular part 160a and the two inner wall parts of the insertion hole in the direction in which the first valve body 141 and the second valve body 142 face each other. Thereby, the support part 141d of the first valve body 141 and the support part 142d of the second valve body 142 can move relative to the rectangular part 160a of the rotating shaft 160. Note that, in a direction perpendicular to the direction in which the first valve body 141 and the second valve body 142 face each other, the two inner walls of the insertion hole are configured to be parallel and flush with each other in the direction of the center axis A, and the two outer walls of the rectangular part 160a and the two outer walls of the insertion hole abut without a gap.

The support part 142d has an axial cross section formed into a substantially U-shape, and a second insertion hole 142f is formed in each of an upper side part and a lower side part of the U-shape. The support part 142d is configured so that the support part 142d of the second valve body 142 is combined with the support part 142d from the open side of the U-shape.

The protruding part 142e faces a protruding part 141e of the first valve body 141 with a gap therebetween. The protruding part 142e determines the position of the center of the coil spring 170. The coil spring 170 is attached to the protruding part 142e.

A coil spring 170 is inserted between the protruding part 141e of the first valve body 141 and the protruding part 142e of the second valve body 142. The coil spring 170 biases the first valve body 141 and the second valve body 142 in a direction that presses against the inner wall part 112 of the housing 110. As a result, the first seal part 141a of the first valve body 141 and the second seal part 142a of the second valve body 142 are brought into close contact with the inner wall part 112 of the housing 110.

As described above, the support part 141d of the first valve body 141 and the support part 142d of the second valve body 142 are configured to be able to move relative to the rectangular part 160a of the rotating shaft 160, so that relative movement between the first valve body 141 and the second valve body 142 in the biasing direction is permitted while suppressing the load in the direction perpendicular to the rotating shaft 160, and the biasing force of the coil spring 170 causes the first seal part 141a of the first valve body 141 and the second seal part 142a of the second valve body 142 to be in close contact with the inner wall part 112 of the housing 110.

Of the plurality of coil springs 170, a pair of coil springs 170 provided in a layer in which a large fluid flow path is formed (herein, the first layer L1) is set to have a larger spring force than the coil springs 170 provided in a layer in which a small fluid flow path is formed (herein, the second layer L2). In other words, of the plurality of coil springs 170, one that is provided at a position with a large pressure-receiving area of the valve body 130 that receives the fluid pressure has a stronger biasing force than the other coil springs that are provided at a position where the pressure-receiving area is small.

In other words, when fluid flows into the second flow path 142b and the second sealing part 142c and the pressure increases, the biasing force of the coil spring 170 increases on the side where the pressure is greater, and the biasing force of the coil spring 170 is smaller on the side where the pressure is less. Thereby, the second seal part 142a can be stably pressed against the inner wall part 112 when fluid pressure is applied, and since there is no need to increase the pressing force more than necessary, the durability of the second seal part 142a can be improved.

The sliding part 142g is provided outside the second flow path 142b so as to be aligned with a portion of the second flow path 142b in the direction of the center axis A, and slides against the inner wall part 112. The sliding part 142g is a protrusion that extends in the circumferential direction and does not itself form a flow path. As a result, when the second valve body 142 is formed asymmetrically in at least one of the direction of the center axis A and the circumferential direction, the sliding part 142g slides against the inner wall part 112, thereby preventing the position of the second valve body 142 from shifting or tilting.

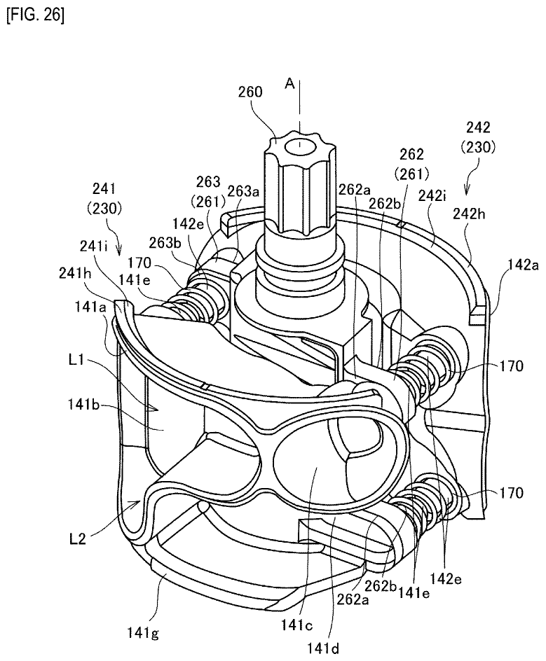

Next, a modified example of the present embodiment will be described with reference to FIG. 26 to FIG. 28.

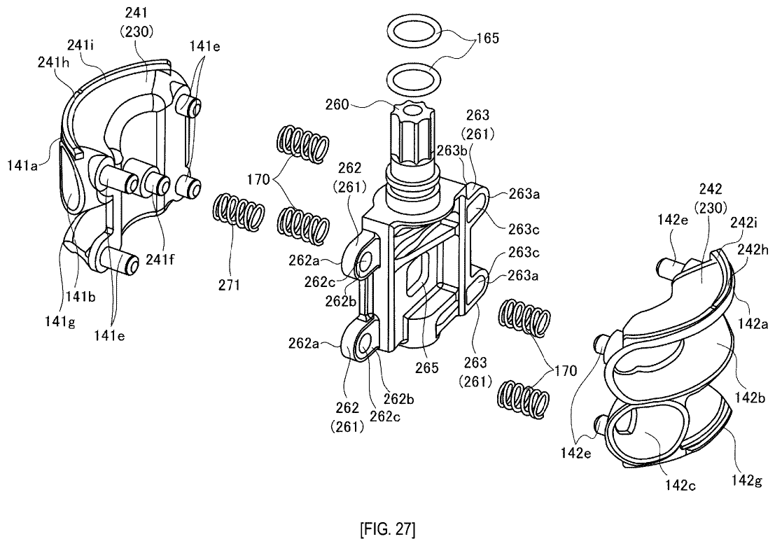

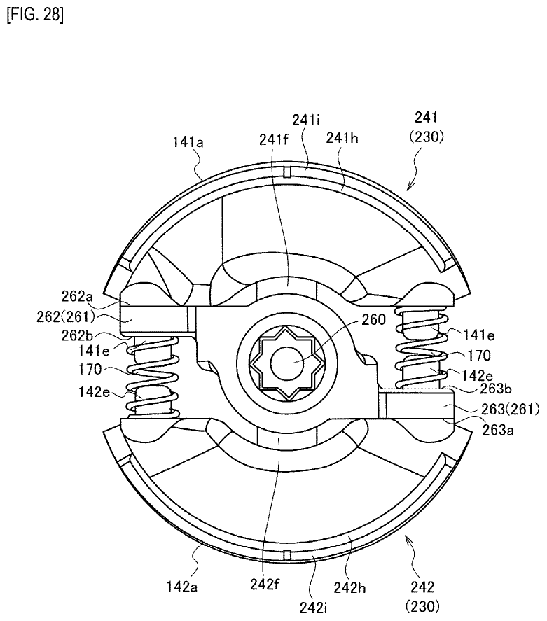

FIG. 26 is a perspective view of a state in which a valve body 230, a rotating shaft 260, and coil springs 170, 271 are combined in a flow path switching valve 101 according to a modified example of the second embodiment of the present invention. FIG. 27 is an exploded perspective view of FIG. 26. FIG. 28 is a plan view of FIG. 26.

As depicted in FIG. 26 to FIG. 28, the flow path switching valve 101 includes a housing 110 (see FIG. 17 to FIG. 19), a valve body 230, a rotating shaft 260, and an actuator 180 (see FIG. 17 to FIG. 19).

The configurations of the housing 110 and the actuator 180 are similar to those of the second embodiment, and therefore a detailed description is omitted.

As depicted in FIG. 26 and FIG. 27, the valve body 230 is accommodated inside the housing 110 so as to be rotatable around the rotating shaft 260. The valve body 230 is capable of being displaced in the radial direction relative to the rotating shaft 260. The valve body 230 has a rotating shaft 260, a plurality of coil springs 170 as biasing members, and a coil spring 271 as a single biasing member.

The valve body 230 switches the connection state of the plurality of ports 113 (see FIG. 17 to FIG. 20). The valve body 230 is provided across the first layer L1 and the second layer L2. The valve body 230 includes a first valve body 241 and a second valve body 242. The first valve body 241 and the second valve body 242 are movable in the radial direction relative to the center axis A of the housing 110, and are biased toward the inner circumferential surface of the housing 110 by a coil spring 170 and the coil spring 271.

As depicted in FIG. 28, the first valve body 241 is formed in a generally semicircular shape. The first valve body 241 is softer than the main body part 11, and also softer than the rotating shaft 260. The first valve body 241 is formed to be larger in the direction of the center axis A so as to span the first layer L1 and the second layer L2. The first valve body 241 is formed asymmetrically in at least one of the direction of the center axis A and the circumferential direction.

The second valve body 242 is formed in a generally semicircular shape. The second valve body 242 is softer than the main body part 11, and also softer than the rotating shaft 260. The second valve body 242 is provided opposite to the first valve body 241 sandwiching the center axis A of the housing 110. The second valve body 242 is formed to be larger in the direction of the center axis A so as to span the first layer L1 and the second layer L2. The second valve body 242 is formed asymmetrically in at least one of the direction of the center axis A and the circumferential direction.

Thus, the valve body 230 includes the first valve body 241 and the second valve body 242 provided in opposing positions centered around the rotating shaft 260. At least one of the first valve body 241 and the second valve body 242 is provided so as to connect with each of the plurality of ports 113 that are provided at different positions (different layers) in the direction of the center axis A among the plurality of ports 113.

Next, specific configurations of the first valve body 241 and the second valve body 242 of the valve body 230 will be described.

The first valve body 241 has a first seal part 141a, a first flow path 141b, a first sealing part 141c, a plurality of (herein, four) protruding parts 141e, a single protruding part 241f, a sliding part 141g, a protruding part 241h, and a curved surface part 241j.

The first seal part 141a, the first flow path 141b, the first sealing part 141c, the protruding part 141e, and the sliding part 141g are similar to those in the second embodiment described above, and therefore a detailed description thereof is omitted here.

The protruding part 241f is provided at approximately the center of the first valve body 241. Specifically, the protruding part 241f is provided approximately at the center of the pair of protruding parts 141e adjacent to each other in the circumferential direction and approximately at the center of a pair of protruding parts 141e adjacent to each other in the axial direction. The protruding part 241f protrudes from the curved surface part 241j toward the inner periphery in the radial direction.

The protruding part 241f faces a protruding part 242f of the second valve body 242 with a gap therebetween. The protruding part 241f determines the position of the center of the coil spring 271. The coil spring 271 is attached to the protruding part 241f.

The protruding parts 241h protrude outward in the direction of the center axis A from both end surfaces of the first valve body 241 in the direction of the center axis A. The protruding part 241h is formed in an arc shape so as to fit along the first seal part 141a of the first valve body 241. One of the protruding parts 241h provided on the cover part 120 side enters a recess part (not depicted) provided on the inner end surface of the cylindrical part 122 of the cover part 120. The other protruding part 241h provided on the bottom part 111a side of the main body part 111 enters a recess part (not depicted) provided in the bottom part 111a. The protruding part 241h has a sliding contact part 241i such that the height of the protruding part 241h increases toward the outer periphery of the first valve body 241.

The sliding contact part 241i abuts with an inclined part (not depicted) provided in the recess part. As a result, when the first valve body 241 deforms outward in the direction of the center axis A due to the pressure of the fluid flowing through the first flow path 141b, the sliding part 241i slides along the inclined part of the recess part, generating a force pressing the first seal part 141a against the inner wall part 112 of the housing 110. Thereby, the first seal part 141a can be brought into tight contact with the inner wall part 112 by utilizing the pressure of the fluid.

The curved surface part 241j is provided on the inner circumferential surface of the first valve body 241. The curved surface part 241j is a curved surface that is concentric with the outer circumferential surface of the first valve body 241. Providing the curved surface part 241j makes the first valve body 241 more easily deformable, so the tolerance between the inner wall part 112 and the first valve body 241 can be absorbed, improving the degree of adhesion.

The second valve body 242 has a second seal part 142a, a second flow path 142b, a second sealing part 142c, a plurality of (herein, four) protruding parts 142e, a single protruding part 242f, a sliding part 142g, a protruding part 242h, and a curved surface part 242j.

The second seal part 142a, the second flow path 142b, the second sealing part 142c, the protruding part 142e, and the sliding part 142g are similar to those in the second embodiment described above, and therefore a detailed description thereof is omitted here.

The protruding part 242f is provided at approximately the center of the second valve body 242. Specifically, the protruding part 242f is provided approximately at the center of the pair of protruding parts 142e adjacent to each other in the circumferential direction and approximately at the center of a pair of protruding parts 142e adjacent to each other in the axial direction. The protruding part 242f protrudes from the curved surface part 242j toward the inner periphery in the radial direction.

The protruding part 242f faces a protruding part 241f of the first valve body 241 with a gap therebetween. The protruding part 242f determines the position of the center of the coil spring 271. The coil spring 271 is attached to the protruding part 242f.

A coil spring 271 is inserted between the protruding part 241f of the first valve body 241 and the protruding part 242f of the second valve body 242. The coil spring 271 is inserted through a through hole 265 (described later) of the rotating shaft 260. The coil spring 271, together with the coil spring 170, biases the first valve body 241 and the second valve body 242 in a direction that presses against the inner wall part 112 of the housing 110. As a result, the first seal part 141a of the first valve body 241 and the second seal part 142a of the second valve body 242 are brought into close contact with the inner wall part 112 of the housing 110.

The protruding parts 242h protrude outward in the direction of the center axis A from both end surfaces of the second valve body 242 in the direction of the center axis A. The protruding part 242h is formed in an arc shape so as to fit along the second seal part 142a of the second valve body 242. One of the protruding parts 242h provided on the cover part 120 side enters a recess part (not depicted) provided on the inner end surface of the cylindrical part 122 of the cover part 120. The other protruding part 242h provided on the bottom part 111a side of the main body part 111 enters a recess part (not depicted) provided in the bottom part 111a. The protruding part 242h has a sliding contact part 242i such that the height of the protruding part 242h increases toward the outer periphery of the second valve body 242.

The sliding contact part 242i abuts with an inclined part (not depicted) provided in the recess part. As a result, when the second valve body 242 deforms outward in the direction of the center axis A due to the pressure of the fluid flowing through the first flow path 142b, the sliding part 242i slides along the inclined part of the recess part, generating a force pressing the second seal part 142a against the inner wall part 112 of the housing 110. Thereby, the second seal part 142a can be brought into tight contact with the inner wall part 112 by utilizing the pressure of the fluid.

The curved surface part 242j is provided on the inner circumferential surface of the second valve body 242. The curved surface part 242j is a curved surface that is concentric with the outer circumferential surface of the second valve body 242. Providing the curved surface part 242j makes the second valve body 242 more easily deformable, so the tolerance between the inner wall part 112 and the second valve body 242 can be absorbed, improving the degree of adhesion.

As depicted in FIG. 26 to FIG. 28, the rotating shaft 260 extends in the direction of the center axis A of the housing 110. The rotating shaft 260 connects the first valve body 241 and the second valve body 242 so as to be movable in opposing directions. Rotating the rotating shaft 260 switches the rotational positions of the first valve body 241 and the second valve body 242.

The rotating shaft 260 has a plurality of arm parts 261 and a through hole 265.

The arm parts 261 extend outward from the rotating shaft 260. The arm parts 261 transmit a rotational force to the valve body 230. The arm parts 261 include first arm parts 262 and second arm parts 263 extending from the rotating shaft 260 in a tangential direction of the rotating shaft 260.

The first arm parts 262 are provided as a pair mutually separated in the direction of the center axis A. The first arm parts 262 have a first contact surface 262a, a first connection surface 262b, and a through hole 262c.

The first contact surface 262a is a flat surface that abuts the first valve body 241. When the rotating shaft 260 rotates in one direction (clockwise in FIG. 28), the first contact surface 262a transmits a force that rotates the first valve body 241 in one direction.

The first connection surface 262b is a flat surface that is connected to the second valve body 242 via the coil spring 170. When the rotating shaft 260 rotates in the other direction (counterclockwise in FIG. 28), the first connecting surface 262b transmits a force that rotates the second valve body 242 in the other direction via the coil spring 170.

The through hole 262c penetrates the first contact surface 262a and the first connecting surface 262b. The protruding part 141e of the first valve body 241 is inserted into the through hole 262c. Note that the protruding part 141e that passes through the through hole 262c is formed to be longer by the thickness of the first arm part 262 than the protruding part 141e that does not pass through the through hole 262c.

The second arm part 263 is provided at a position having a phase difference of 180 degrees with respect to the first arm part 262. In other words, the second arm part 263 is provided at a position rotationally symmetrical with respect to the first arm part 262. The second arm parts 263 are provided as a pair mutually separated in the direction of the center axis A. The second arm parts 263 have a second contact surface 263a, a second connection surface 263b, and a through hole 263c.

The second contact surface 263a is a flat surface that abuts the second valve body 242. When the rotating shaft 260 rotates in one direction (clockwise in FIG. 28), the second contact surface 263a transmits a force that rotates the second valve body 242 in one direction.

The second connection surface 263b is a flat surface that is connected to the first valve body 241 via the coil spring 170. When the rotating shaft 260 rotates in the other direction (counterclockwise in FIG. 28), the second connecting surface 263b transmits a force that rotates the first valve body 241 in the other direction via the coil spring 170.

The through hole 263c penetrates the second contact surface 263a and the second connecting surface 263b. The protruding part 142e of the second valve body 242 is inserted into the through hole 263c. Note that the protruding part 142e that passes through the through hole 263c is formed to be longer by the thickness of the second arm part 263 than the protruding part 142e that does not pass through the through hole 263c.

The through hole 265 is formed approximately in the center between the first arm part 262 and the second arm part 263. The through hole 265 passes through the coil spring 170 and the coil spring 271 in the center axis direction. The through hole 265 is formed in a substantially rectangular shape. A coil spring 271 is inserted into the through hole 265.

The coil spring 271 is provided between the first valve body 241 and the second valve body 242. The coil spring 271 biases both the first valve body 241 and the second valve body 242 toward the inner wall part 112 where the port 113 is formed. By providing the coil spring 271, the approximate centers of the first valve body 241 and the second valve body 242 can be biased in the circumferential direction toward the inner wall part 112. As a result, the first valve body 241 and the second valve body 242 are pressed against the inner wall part 112 near both circumferential end parts by the biasing force of the coil spring 170, and the proximity of the circumferential center part is pressed to the inner wall part 112 by the biasing force of the coil spring 271. Therefore, the first valve body 241 and the second valve body 242 can be pressed against the inner wall part 112 over the entire region in the circumferential direction.

As described above, by providing the arm part 261, a rotational force can be applied from the arm part 261 to the first valve body 241 and the second valve body 242, so that the structure of the valve body 230 can be simplified. In addition, the amount of resin material used to mold the first valve body 241 and the second valve body 242 can be reduced.

Furthermore, by providing the coil spring 170 and the coil spring 271, the number of biasing members can be increased so as to increase the number of biased locations, and thus the biasing force of the individual coil springs 170 and 271 can be reduced.

Furthermore, when the valve body 230 in the present modified example is rotated in the other direction (counterclockwise in FIG. 28), the arm part 261 is compressed by pressing the coil spring 170, pushing and driving the rear end side of the valve body 230 in the rotational direction, while the biasing force toward the front end side of the valve body 230 no longer acts in the rotational direction. Thereby, the sliding resistance is reduced when the valve body 230 rotates, thus reducing the operating torque.

Furthermore, the first valve body 241 and the second valve body 242 are flexible, so the degree of contact of the first valve body 241 and the second valve body 242 to the inner wall part 112 can be increased.

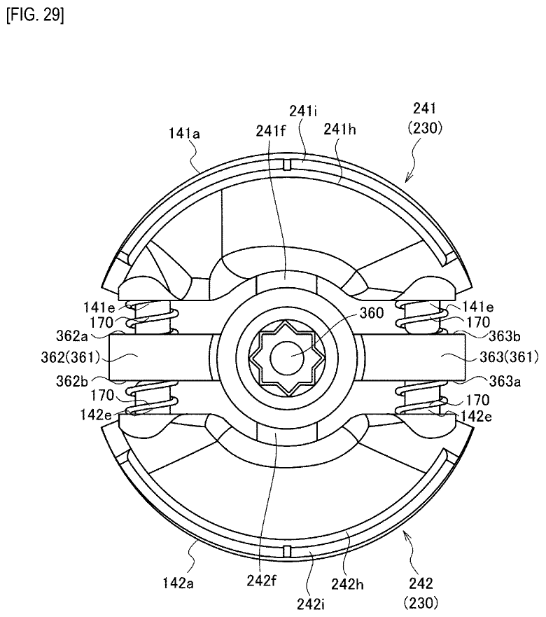

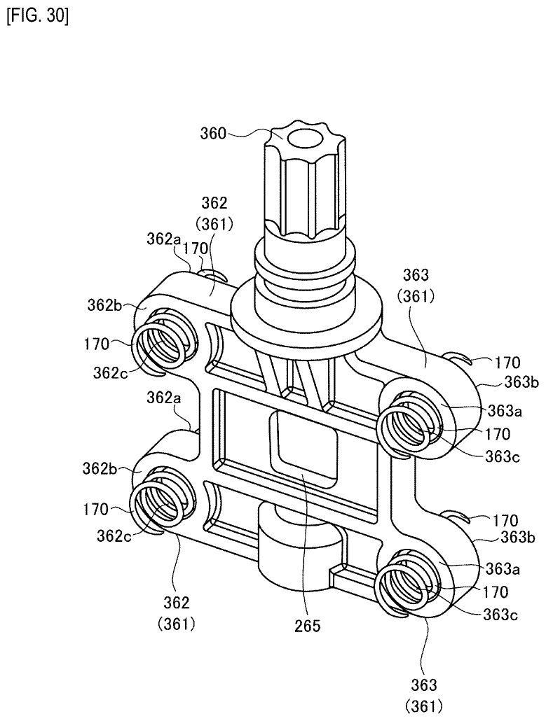

Next, another modified example of the present embodiment will be described with reference to FIG. 29 and FIG. 30.

FIG. 29 is a plan view of a flow path switching valve 101 according to another modified example of the second embodiment of the present invention. FIG. 30 is a perspective view of the rotating shaft 360 in FIG. 29.

The present modified example differs from the modified examples depicted in FIG. 26 to FIG. 28 in the position of the arm part 361 provided on the rotating shaft 360.

The rotating shaft 360 has a plurality of arm parts 361 and a through hole 265.

The arm parts 361 extend outward from the rotating shaft 360. The arm parts 361 transmit the rotational force to the valve body 230. The arm parts 361 include first arm parts 362 and second arm parts 363 extending from the rotating shaft 360 in a tangential direction of the rotating shaft 360.

The first arm parts 362 are provided as a pair mutually separated in the direction of the center axis A. The first arm part 362 has a first connecting surface 362a, a second connecting surface 362b, and a countersunk part 362c.

The first connection surface 362a is a flat surface that is connected to the first valve body 241 via the coil spring 170. When the rotating shaft 260 rotates in one direction (clockwise in FIG. 29), the first connecting surface 362a transmits a force that rotates the first valve body 241 in one direction via the coil spring 170.

The second connection surface 362b is a flat surface that is connected to the second valve body 242 via the coil spring 170. When the rotating shaft 360 rotates in the other direction (counterclockwise in FIG. 29), the second connecting surface 362b transmits the force that rotates the second valve body 242 in the other direction via the coil spring 170.

The countersunk part 362c is formed in a concave shape on each of the first connecting surface 362a and the second connecting surface 362b. An end of the coil spring 170 abuts against the countersunk part 362c. Note that in the present modified example, no through holes are provided, so all of the protruding parts 141e are formed to have the same length.

The second arm part 363 is provided at a position having a phase difference of 180 degrees with respect to the first arm part 362. In other words, the second arm part 363 is provided at a position rotationally symmetrical with respect to the first arm part 362. The second arm parts 363 are provided as a pair mutually separated in the direction of the center axis A. The second arm part 363 has a third connecting surface 363a, a fourth connecting surface 363b, and a countersunk part 363c.

The third connection surface 363a is a flat surface that is connected to the second valve body 242 via the coil spring 170. When the rotating shaft 360 rotates in one direction (clockwise in FIG. 29), the third connecting surface 363a transmits a force that rotates the second valve body 242 in one direction via the coil spring 170.

The fourth connection surface 363b is a flat surface that is connected to the first valve body 241 via the coil spring 170. When the rotating shaft 360 rotates in the other direction (counterclockwise in FIG. 29), the fourth connecting surface 363b transmits the force that rotates the first valve body 241 in the other direction via the coil spring 170.

The countersunk part 363c is formed in a concave shape on each of the third connecting surface 363a and the fourth connecting surface 363b. An end of the coil spring 170 abuts against the countersunk part 363c. Note that in the present modified example, no through holes are provided, so all of the protruding parts 142e are formed to have the same length.

The through hole 265 and the coil spring 271 are similar to those in the modified example depicted in FIG. 26 to FIG. 28, and therefore a detailed description thereof will be omitted here.

As described above, by providing the arm part 361, a rotational force can be applied from the arm part 361 to the first valve body 241 and the second valve body 242, so that the structure of the valve body 230 can be simplified. In addition, the amount of resin material used to mold the first valve body 241 and the second valve body 242 can be reduced.

Furthermore, in the modified example, the pair of arm parts 361 are connected to the first valve body 241 and the second valve body 242 via the coil spring 170. Therefore, when the valve body 230 is rotated, the arm part 361 presses the coil spring 170, compressing and pushing to drive the rear end side of the valve body 230 in the rotational direction, while the coil spring 170 expands on the front end side of the valve body 230 in the rotational direction, thereby reducing the biasing force. Thereby, the sliding resistance is reduced when the valve body 230 rotates, thus reducing the operating torque. Note that in the present modified example, the coil spring 170 is provided between both sides of the arm part 361 and the valve body 230, so the effect of reducing the operating torque can be obtained regardless of the direction of rotation.

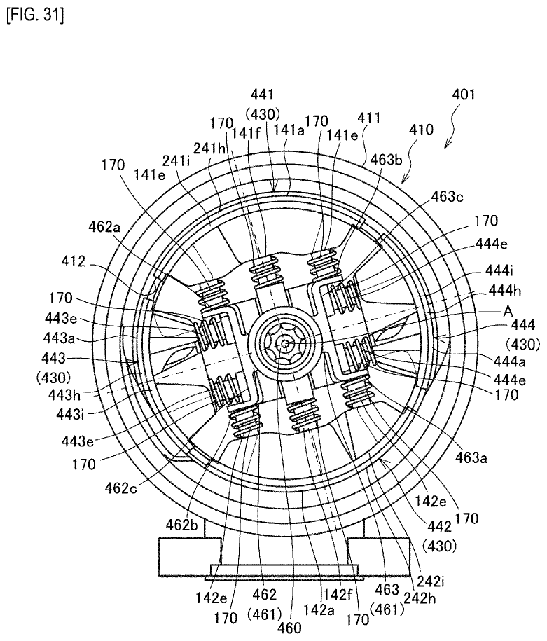

Next, yet another modified example of the present embodiment will be described with reference to FIG. 31.

FIG. 31 is a plan view of a flow path switching valve 401 according to yet another modified example of the second embodiment of the present invention, depicting a state in which the cover part (not depicted) is removed from the housing 410.

The present modified example differs from the modified example depicted in FIG. 29 and FIG. 30 in that the valve body 430 has a third valve body 443 and a fourth valve body 444 in addition to a first valve body 441 and a second valve body 442.

The valve body 430 is accommodated inside the housing 410 so as to be rotatable around the rotating shaft 460. The valve body 430 is capable of being displaced in the radial direction relative to the rotating shaft 460. The valve body 430 has a rotating shaft 460 and a plurality of coil springs 170 serving as biasing members.

The valve body 430 switches the connection state of the plurality of ports (not depicted). The valve body 430 has a first valve body 441, a second valve body 442, a third valve body 443, and a fourth valve body 444. The first valve body 441, the second valve body 442, the third valve body 443, and the fourth valve body 444 are movable radially relative to the center axis A of the housing 110, and are biased toward the inner circumferential surface (inner wall part 412) of the housing 410 by the coil spring 170 described below.

The first valve body 441 has an arc shape across an angle of approximately 90° about the center axis A. The first valve body 441 is softer than the main body part 411 of the housing 410, and also softer than the rotating shaft 460. The first valve body 441 has a similar configuration to the first valve body 241 except for the circumferential size, and therefore a detailed description thereof will be omitted.

The second valve body 442 is formed in an arc shape across an angle of approximately 90° about the center axis A. The second valve body 442 is softer than the main body part 411 of the housing 410, and also softer than the rotating shaft 460. The second valve body 442 is provided opposite to the first valve body 441 sandwiching the center axis A of the housing 410. The second valve body 442 has a similar configuration to the second valve body 242 except for the circumferential size, and therefore a detailed description thereof will be omitted.

The third valve body 443 is formed in an arc shape across an angle of less than 90° (herein approximately 60°) about the center axis A. The third valve body 443 is softer than the main body part 411 of the housing 410, and also softer than the rotating shaft 460.

The third valve body 443 has a third seal part 443a, a plurality of protruding parts 443e, a protruding part 443h, a protruding part 443h, and a sliding contact part 443i. The third seal part 443a, the protruding part 443e, the protruding part 443h, and the sliding contact part 443i have the same configuration as the first seal part 141a, the protruding part 141e, the protruding part 241h, and the sliding contact part 241i, so a detailed description is omitted.

The fourth valve body 444 is formed in an arc shape across an angle of less than 90° (herein approximately 60°) about the center axis A. The fourth valve body 444 is softer than the main body part 411 of the housing 410, and also softer than the rotating shaft 460. The fourth valve body 444 is provided opposite to the third valve body 443 sandwiching the center axis A of the housing 410.

The fourth valve body 444 has a fourth seal part 444a, a plurality of protruding parts 444e, a protruding part 444h, and a sliding contact part 444i. The fourth seal part 444a, the protruding part 444e, the protruding part 444h, and the sliding contact part 444i have the same configuration as the second seal part 142a, the protruding part 142e, the protruding part 242h, and the sliding contact part 242i, so a detailed description is omitted.

The direction in which the first valve body 441 faces the second valve body 442 is perpendicular to the direction in which the third valve body 443 faces the fourth valve body 444. In other words, the first valve body 441, the fourth valve body 444, the second valve body 442, and the third valve body 443 are provided in order with a phase difference of 90° in the rotational direction.

The rotating shaft 460 extends in the direction of the center axis A of the housing 410. The rotating shaft 460 connects the first valve body 441 and the second valve body 442 to move in opposing directions, and connects the third valve body 443 and the fourth valve body 444 to move in opposing directions. Rotating the rotating shaft 460 switches the rotational positions of the first valve body 441, the second valve body 442, the third valve body 443, and the fourth valve body 444.

The rotating shaft 460 has a plurality of arm parts 461.

The arm parts 461 extend outward from the rotating shaft 460. The arm parts 461 transmit the rotational force to the valve body 430. The arm parts 461 include first arm parts 462 and second arm parts 463 extending from the rotating shaft 460 in a tangential direction of the rotating shaft 460.

The first arm parts 462 are provided as a pair mutually separated in the direction of the center axis A (not depicted). The first arm part 462 has a first connecting surface 462a, a second connecting surface 462b, and a third connecting surface 462c.

The first connection surface 462a is a flat surface that is connected to the first valve body 441 via the coil spring 170. When the rotating shaft 460 rotates in one direction (clockwise in FIG. 31), the first connecting surface 462a transmits a force that rotates the first valve body 441 in one direction via the coil spring 170.

The second connection surface 462b is a flat surface that is connected to the second valve body 442 via the coil spring 170. When the rotating shaft 460 rotates in the other direction (counterclockwise in FIG. 31), the second connecting surface 462b transmits the force that rotates the second valve body 442 in the other direction via the coil spring 170.

The third connection surface 462c is provided between the first connection surface 462a and the second connection surface 462b. The third connection surface 462c is a plane perpendicular to the first connection surface 462a and the second connection surface 462b. The third connection surface 462c is formed in a concave shape from the end surface of the first arm part 462. A plurality of coil springs 170 abut against the third connection surface 462c. When the rotating shaft 460 rotates, the third connection surface 462c transmits the force that rotates the third valve body 443 via the coil spring 170.

The second arm part 463 is provided at a position having a phase difference of 180 degrees with respect to the first arm part 462. In other words, the second arm part 463 is provided at a position rotationally symmetrical with respect to the first arm part 462. The second arm parts 463 are provided as a pair mutually separated in the direction of the center axis A (not depicted). The second arm part 463 has a fourth connecting surface 463a, a fifth connecting surface 463b, and a sixth connecting surface 463c.

The fourth connection surface 463a is a flat surface that is connected to the second valve body 442 via the coil spring 170. When the rotating shaft 460 rotates in one direction (clockwise in FIG. 31), the fourth connecting surface 463a transmits a force that rotates the second valve body 442 in one direction via the coil spring 170.

The fifth connection surface 463b is a flat surface that is connected to the first valve body 441 via the coil spring 170. When the rotating shaft 460 rotates in the other direction (counterclockwise in FIG. 31), the fifth connecting surface 463b transmits the force that rotates the first valve body 441 in the other direction via the coil spring 170.

The sixth connection surface 463c is provided between the fourth connection surface 463a and the fifth connection surface 463b. The sixth connection surface 463c is a plane perpendicular to the fourth connection surface 463a and the fifth connection surface 463b. The sixth connection surface 463c is formed in a concave shape from the end surface of the second arm part 463. A plurality of coil springs 170 abut against the sixth connection surface 463c. When the rotating shaft 460 rotates, the sixth connection surface 463c transmits the force that rotates the fourth valve body 444 via the coil spring 170.

As described above, by providing the arm part 461, a rotational force can be applied from the arm part 461 to the first valve body 441, the second valve body 442, the third valve body 443, and the fourth valve body 444, so that the structure of the valve body 430 can be simplified. In addition, the amount of resin material used to mold the first valve body 441, the second valve body 442, the third valve body 443, and the fourth valve body 444 can be reduced.

Furthermore, similar to the arm part 461, the arm part may have a prescribed thickness (prescribed width) around the center axis A. In other words, similar to the arm part 461, the arm part may have a thickness (width) with a prescribed angle in the circumferential direction (the direction of rotation about the center axis A). In other words, the arm part 461 may have at least two points involved in rotating the valve body 430 (either by direct contact or by indirect connection via the coil spring 170).

Furthermore, similar to the arm part 461, a third connection surface 462c (sixth connection surface 463c) may be provided between the first connection surface 462a (fourth connection surface 463a) and the second connection surface 462b (fifth connection surface 463b), and a coil spring 170 may be provided on the third connection surface 462c (sixth connection surface 463c) to bias the other valve bodies 430 (third valve body 443 and fourth valve body 444).

Furthermore, in the present modified example, the arm parts 461 are connected to the valve body 430 via the coil spring 170. Therefore, when the valve body 430 is rotated, the arm part 461 presses the coil spring 170, compressing and pushing to drive the rear end side of the valve body 430 in the rotational direction, while the coil spring 170 expands on the front end side of the valve body 430 in the rotational direction, thereby reducing the biasing force. Thereby, the sliding resistance is reduced when the valve body 430 rotates, thus reducing the operating torque. Note that in the present modified example, the coil spring 170 is provided between the arm part 461 and the valve body 430, so the effect of reducing the operating torque can be obtained regardless of the direction of rotation.

Note that in the above embodiment and each modified example, a pair of four valve bodies 130, 230, 430 are provided around the rotating shafts 160, 260, 360, 460, respectively. However, the number of valve bodies 130, 230, 430 is not limited to an even number, and an odd number (three, five, and the like) of valve bodies may be provided in the rotational direction. Even if an odd number of valve bodies 130, 230, 430 are provided, the effect of increasing the degree of contact while reducing the operating torque can be obtained by arranging coil springs 170 at the front and rear ends of the valve bodies 130, 230, 430 in the rotational direction, as in the above embodiment and each modified example.

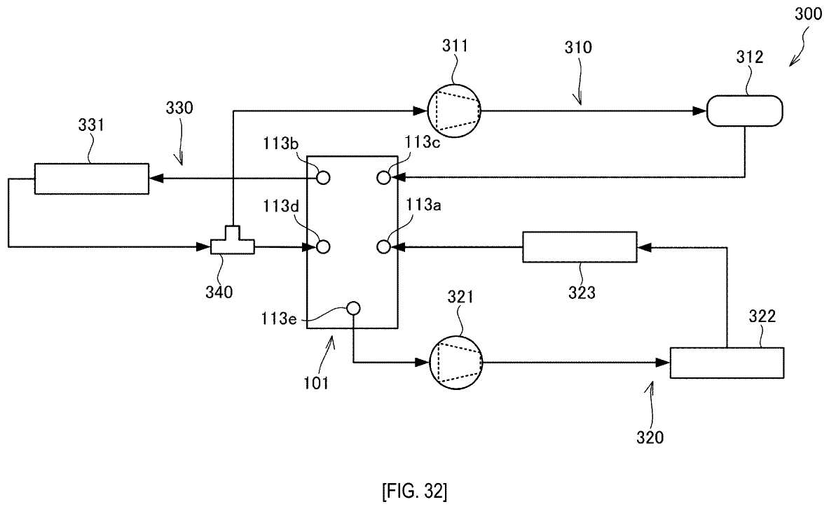

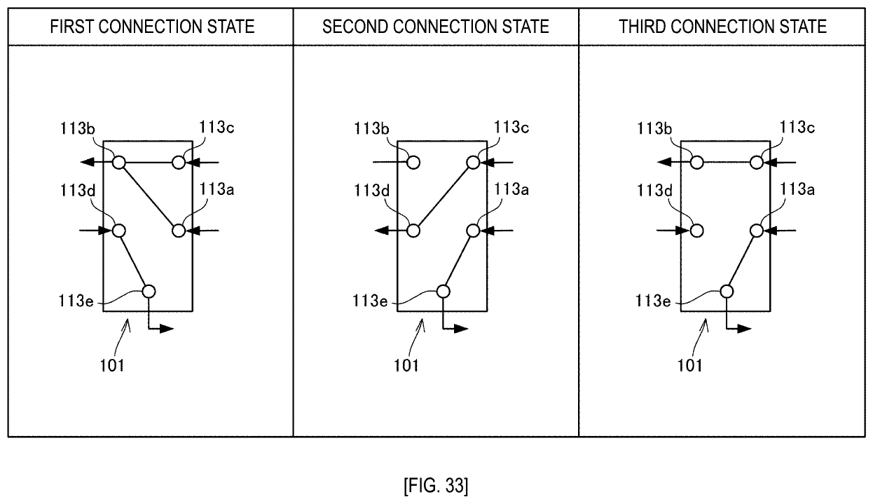

Next, a fluid circuit 300 to which the flow path switching valve 101 is applied will be described with reference to FIG. 32 and FIG. 33.

FIG. 32 is a configuration diagram depicting an example of a fluid circuit 300 to which a flow path switching valve 101 is applied. FIG. 33 is a configuration diagram for describing first to third connection states of the flow path switching valve 101.

As depicted in FIG. 32, the fluid circuit 300 includes a powertrain circuit 310 as a first circuit, a battery circuit 320 as a second circuit, a radiator circuit 330 as a third circuit, and a branch part 340. The fluid circuit 300 is a system mounted on a vehicle (not depicted), which cools an electric motor 312 serving as a heat generating body in the drive system, and adjusts the temperature of a battery 322 serving as a storage battery. Cooling water circulates as a fluid through the fluid circuit 300.

The powertrain circuit 310 is provided with an electric pump 311 and an electric motor 312. The cooling water flowing out from the second port 113b of the flow path switching valve 101 flows into the power train circuit 310 via a radiator 331 and a branch part 340. In the powertrain circuit 310, the electric pump 311 drives the cooling water through the electric motor 312. The cooling water flowing out from the powertrain circuit 310 flows again into the flow path switching valve 101 from the third port 113c.

The battery circuit 320 is provided with an electric pump 321, a battery 322, and a chiller 323 serving as a cooling water-refrigerant heat exchanger. The cooling water flowing out from the fifth port 113e of the flow path switching valve 101 flows into the battery circuit 320. In the battery circuit 320, the electric pump 321 circulates the cooling water through the battery 322 and the chiller 323. The chiller 323 exchanges heat between the refrigerant and the cooling water flowing through a refrigeration cycle circuit (not depicted) of an air conditioning device that conditions the air inside a vehicle compartment (not depicted). The chiller 323 is capable of heating the refrigerant by the heat of the cooling water, and heating the cooling water by the heat of the refrigerant. The cooling water flowing out from the battery circuit 320 flows again into the flow path switching valve 101 from the first port 113a.

The radiator circuit 330 is provided with a radiator 331. The cooling water flowing out from the second port 113b of the flow path switching valve 101 flows into the radiator circuit 330. The radiator circuit 330 does not have an electric pump. The cooling water in the radiator circuit 330 flows through the radiator 331 by either one of the electric pumps 311 and 321 or a combination of both, based on the connection state of the flow path switching valve 101. The cooling water flowing out from the radiator circuit 330 is branched by the branch part 340, with one portion being guided to the powertrain circuit 310 and the remainder flowing back into the flow path switching valve 101 from the fourth port 113d.

As depicted in FIG. 33, in the fluid circuit 300, the valve body 130 is rotated to switch the connection state of the plurality of ports 113 in the flow path switching valve 101 to a first connection state, a second connection state, or a third connection state. Thereby, the flow of cooling water is controlled in the fluid circuit 300.

In the first connection state, in the valve body 130, the second flow path 142b of the second valve body 142 connects the first port 113a, the second port 113b, and the third port 113c. Additionally, the first valve body 141 and the second valve body 142 connect the fourth port 113d and the fifth port 113e with the connecting part 115. In other words, the fourth port 113d and the fifth port 113e are connected together by the connecting part 115.

Thereby, the power train circuit 310, the battery circuit 320, and the radiator circuit 330 can all be connected together. At this time, the cooling water in the radiator circuit 330 is circulated by a combination of both electric pumps 311 and 321.

In the second connection state, in the valve body 130, the first flow path 141b of the first valve body 141 connects between the third port 113c and the fourth port 113d, and the first sealing part 141c seals the second port 113b. Additionally, the first valve body 141 and the second valve body 142 connect the first port 113a and the fifth port 113e with the connecting part 115. In other words, the first port 113a and the fifth port 113e are connected together by the connecting part 115.

Thereby, the power train circuit 310, the battery circuit 320, and the radiator circuit 330 can all be isolated. At this time, the radiator circuit 330 is not provided with an electric pump, so the cooling water does not flow through the radiator circuit 330.

In the third connection state, in the valve body 130, the second flow path 142b of the second valve body 142 connects between the second port 113b and the third port 113c, and the second sealing part 142c seals the fourth port 113d. Additionally, the first valve body 141 and the second valve body 142 connect the first port 113a and the fifth port 113e with the connecting part 115. In other words, the first port 113a and the fifth port 113e are connected together by the connecting part 115.

Thereby, the powertrain circuit 310 and the radiator circuit 330 are connected, and the battery circuit 320 can be isolated.

As described above, in the fluid circuit 300, the connection state of the plurality of ports 113 in the flow path switching valve 101 can be switched between the first to third connection states. Furthermore, in each connection state, the electric motor 312 can be cooled, the temperature of the battery 322 can be adjusted, and the refrigerant used for air conditioning in the vehicle cabin via the chiller 323 can be heated and cooled.

With the aforementioned second embodiment, the following effects are achieved in addition to the same effects as those of the first embodiment.

At least one of the first flow path 141b and the second flow path 142b is configured to connect with each of the plurality of ports 113 that are provided at different positions in the direction of the center axis A, and the coil springs 170 are provided in plurality at two locations spaced apart in the direction of the center axis A.

Furthermore, the center axes of the plurality of coil springs 170 are provided such that the position in the direction of the center axis A matches a center axis of the port 113.

In addition, of the plurality of coil springs 170, one that is provided at a position along the center axis A with a large pressure-receiving area of the valve body 130 that receives the fluid pressure has a stronger biasing force than the others that are provided at a position along the center axis A with a smaller pressure-receiving area.

With these configurations, when fluid pressure is applied, the first seal part 141a and the second seal part 142a can be stably pressed against the inner wall part 112, and thus excessively increasing the pressing force is not necessary, thereby improving the durability of the first seal part 141a and the second seal part 142a.

Furthermore, of the edge part of the valve body 130 that faces the inner wall part 112, only a portion of the inner circumferential side in the thickness direction abuts against the inner wall part 112 to form a seal surface.

With this configuration, the contact area between the first seal part 141a (second seal part 142a) and the inner wall part 112 is reduced, and the sliding resistance is reduced. Therefore, the driving torque by the actuator 180 can be reduced. In addition, when a fluid flows into the first flow path 141b (second flow path 142b) and the pressure increases, even if the free end of the first seal part 141a (second seal part 142a) deforms toward the outer periphery, the contact state can be maintained between the first seal part 141a (second seal part 142a) and the inner wall part 112. Therefore, the seal performance of the first seal part 141a (second seal part 142a) can be maintained.

Furthermore, the housing 110 has a sliding resistance reducing part that reduces the sliding resistance of the valve body 130 on the inner wall part 112 where the port 113 is formed and the inner wall part 112 at other positions facing across the rotating shaft 160. The sliding resistance reducing part is a slit 116 provided in the inner wall part 112 of the housing 110 and extending in the direction of the center axis A.

With this configuration, the drive torque of the actuator 180 can be reduced, enabling use of a small actuator 180. Therefore, the entire flow path switching valve 101 can be made compact.

At least one of the first flow path 141b and the second flow path 142b is provided to connect with each of the plurality of ports 113 that are provided at different positions in the direction of the center axis A, and at least one of the first valve body 141 and the second valve body 142 is provided outside the first flow path 141b and the second flow path 142b so as to be aligned in the direction of the center axis A with a portion of the first flow path 141b and the second flow path 142b, and has a sliding part 141g (sliding part 142g) that slides against the inner wall part 112.

With this configuration, when at least one of the first valve body 141 and the second valve body 142 is formed asymmetrically in at least one of the direction of the center axis A and the circumferential direction, the sliding part 141g (sliding part 142g) slides against the inner wall part 112, thereby preventing the position of the first valve body 141 (second valve body 142) from shifting or tilting.

In addition, the rotating shaft 260 has an arm part 261 that extends outward from the rotating shaft 260 and transmits a rotational force to the valve body 230.

In addition, the arm part 261 includes a first arm part 262 and a second arm part 263 extending from the rotating shaft 260 in a tangential direction of the rotating shaft 260. The first arm part 262 has a first contact surface 262a that abuts against the first valve body 241 and a first connection surface 262b connected to the second valve body 242 via the coil spring 170, and the second arm part 263 has a second contact surface 263a that abuts against the second valve body 242 and a second connection surface 263b that is connected to the first valve body 241 via the coil spring 170.

Furthermore, a pair of arm parts 361 are provided to extend in the radial direction of the rotating shaft 360 from the rotating shaft 360, and the pair of arm parts 361 are connected to the first valve body 241 and the second valve body 242 via the coil spring 170.

With these configurations, a rotational force can be applied from the arm parts 261, 361 to the first valve body 241 and the second valve body 242 by providing the arm parts 261, 361, and thus the structure of the valve body 230 can be simplified. In addition, the amount of resin material used to mold the first valve body 241 and the second valve body 242 can be reduced.

The first valve body 241 and the second valve body 242 are softer than the main body part 111. The first valve body 241 and the second valve body 242 are also softer than the rotating shaft 260.

With these configurations, the first valve body 241 and the second valve body 242 are flexible, so the degree of contact of the first valve body 241 and the second valve body 242 to the inner wall part 112 can be increased.

In addition, three or more valve bodies 130, 230, 430 are provided, including first valve bodies 141, 241, 441 and second valve bodies 142, 242, 442, aligned around the rotating shafts 160, 260, 360, 460, and the arm parts 261, 361, 461 extending between adjacent valve bodies 130, 230, 430 in the rotational direction. One side of the arm parts 261, 361, 461 in the rotational direction is connected to the adjacent valve body 130, 230, 430 in one rotational direction via a coil spring 170, and the side in the other rotational direction abuts against the valve body 130, 230, 430 or is connected to the adjacent valve body 130, 230, 430 in the other the rotational direction via the coil spring 170.

With this configuration, even if an odd number of valve bodies 130, 230, 430 are provided, the effect of increasing the degree of contact while reducing the operating torque can be obtained by arranging coil springs 170 at the front and rear ends of the valve bodies 130, 230, 430 in the rotational direction, as in the above embodiment and each modified example.

Embodiments of the present invention have been described above, so the above-mentioned embodiments merely depict some of the application examples of the present invention, and are not intended to restrict the technical scope of the present invention to the specific configurations of the above-mentioned embodiments.

In the first embodiment, the first flow path 21b of the first valve body 21 and the second flow path 22b of the second valve body 22 are both configured to connect with a plurality of ports 40 that are within an angular range of 90 degrees, but this is not a limitation, and the valve bodies may be configured to connect with a plurality of ports 40 that are within a range of, for example, 45 degrees.

The present application claims priority based on Japanese Patent Application No. 2022-203747 filed with the Japan Patent Office on Dec. 20, 2022, Japanese Patent Application No. 2023-062269 filed with the Japan Patent Office on Apr. 6, 2023, Japanese Patent Application No. 2023-073753filed with the Japan Patent Office on Apr. 27, 2023, and Japanese Patent Application No. 2023-125572 filed with the Japan Patent Office on Aug. 1, 2023, the entire contents of which are incorporated herein by reference.

1. A flow path switching valve, comprising:
a housing including a main body part having a cylindrical inner wall part and a plurality of ports opening in a circumferential direction, a bottom part covering a first end of the main body part in a center axis direction, and a cover part covering a second end of the main body part in the center axis direction;
a valve body stored inside the housing so as to be rotatable about the center axis, the valve body including a set of a first valve body and a second valve body positioned around the center axis, the valve body being in sliding contact with the inner wall part to switch the connection state between the plurality of ports;
a rotating shaft extending in the center axis direction, connecting the first valve body and the second valve body so as to be movable in a radial direction, and switching rotational position of the first valve body and the second valve body by rotating the rotating shaft; and
a biasing member that biases the first valve body and the second valve body toward the inner wall part.

2. The flow path switching valve according to claim 1, wherein
the first valve body and the second valve body are provided at positions facing each other about the center axis and are movable in the facing direction; and
the biasing member is provided between the first valve body and the second valve body, and biases both the first valve body and the second valve body toward the inner wall part.

3. The flow path switching valve according to claim 2, wherein
the first valve body and the second valve body each have an insertion hole into which the rotating shaft is inserted;
when the rotating shaft is inserted into the insertion hole, a gap is provided between the tip end part of the rotating shaft and the insertion hole in the opposing direction; and
the tip end part of the rotating shaft and the insertion hole abut against each other without a gap in a direction perpendicular to the direction in which the first valve body and the second valve body face each other.

4. The flow path switching valve according to claim 2, wherein
the inside of the housing is partitioned into:
a first space enclosed by the first valve body and the inner wall part, a second space enclosed by the second valve body and the inner wall part, and a third space enclosed by the first valve body, the second valve body, and the inner wall part.

5. The flow path switching valve according to claim 4, wherein
the first valve body has a first seal part, and the first space is enclosed by the first seal part and the inner wall part so as to form a first flow path that is a space through which a fluid flows;
the ports include a first port and a second port provided at a prescribed angle relative to each other about the rotating shaft; and
the first valve body switches between a first state in which the first port and the second port mutually connect through the first flow path, and a second state in which the first port and the second port do not mutually connect, by rotation of the rotating shaft.

6. The flow path switching valve according to claim 5, wherein
the second valve body has a second seal part, and the second space is enclosed by the second seal part and the inner wall part so as to form a second flow path that is a space through which a fluid flows;
the ports further include a third port and a fourth port that are provided symmetric to the first port and the second port with respect to the center axis, and that are provided at a prescribed angle to each other around the rotating shaft; and
in the first state, the second valve body connects with the third port and the fourth port through the second flow path, and in the second state, the second valve body does not connect between the third port and the fourth port.

7. The flow path switching valve according to claim 6, wherein
the third space forms a third flow path through which a fluid flows between the first valve body, the second valve body, and the inner wall part;
the ports further include a fifth port provided between the first port and the third port, and a sixth port provided between the second port and the fourth port; and
the third flow path connects with the fifth port and the sixth port.

8. The flow path switching valve according to claim 4, wherein
at least one of the first space and the second space is provided to connect with each of the plurality of ports that are provided at different positions in the center axis direction; and
the biasing member is provided in plurality at two locations spaced apart in the center axis direction.

9. The flow path switching valve according to claim 8, wherein
the center axes of the plurality of biasing members are provided such that the position in the center axis direction matches a center axis of the port.

10. The flow path switching valve according to claim 9, wherein
one of the plurality of biasing members provided at a position in the center axis direction with a large pressure-receiving area of the valve body that receives the pressure of the fluid has a larger biasing force than the other biasing members provided at a position in the center axis direction with a small pressure-receiving area.

11. The flow path switching valve according to claim 1, wherein
the valve body has an edge part facing the inner wall part, and only a portion of the inner circumferential side in a thickness direction abuts against the inner wall part to form a seal surface.

12. The flow path switching valve according to claim 1, wherein
the housing has a sliding resistance reducing part that reduces sliding resistance between the inner wall part where the port is formed and the valve body in the inner wall part at another position opposite to the inner wall part where the port is formed sandwiching the rotating shaft.

13. The flow path switching valve according to claim 12, wherein
the sliding resistance reducing part is a slit extending in the center axis direction on the inner wall part of the housing.

14. The flow path switching valve according to claim 4, wherein
at least one of the first space and the second space is provided to connect with each of the plurality of ports that are provided at different positions in the center axis direction; and
at least one of the first valve body and the second valve body is provided outside the first space and the second space so as to be aligned with a portion of the first space and the second space in the center axis direction, and has a sliding part that slides against the inner wall part.

15. The flow path switching valve according to claim 1, wherein
the valve body is displaceable in a radial direction relative to the rotating shaft.

16. The flow path switching valve according to claim 15, wherein
the rotating shaft has an arm part extending outward from the rotating shaft to transmit a rotational force to the valve body.

17. The flow path switching valve according to claim 16, wherein
the arm part includes a first arm part and a second arm part extending from the rotating shaft in a tangential direction of the rotating shaft;
the first arm part has a first contact surface that contacts the first valve body and a first connection surface that is connected to the second valve body via the biasing member; and
the second arm part has a second contact surface that contacts the second valve body and a second connection surface that is connected to the first valve body via the biasing member.

18. The flow path switching valve according to claim 16, wherein
the arm parts are provided as a pair so as to extend from the rotating shaft in a radial direction of the rotating shaft; and
the pair of arm parts are connected to the first valve body and the second valve body via the biasing member.

19. The flow path switching valve according to claim 1, wherein
the first valve body and the second valve body are softer than the main body part.

20. The flow path switching valve according to claim 1, wherein
the first valve body and the second valve body are softer than the rotating shaft.

21. The flow path switching valve according to claim 16, wherein
three or more valve bodies including the first valve body and the second valve body are provided so as to be aligned around the rotating shaft;
the arm parts each extend between adjacent valve bodies in a rotational direction; and
one side of the arm part in the rotation direction is connected to the adjacent valve body in the one direction of the rotation direction via the biasing member, and the other side of the arm in the rotation direction is in contact with the valve body or is connected to the adjacent valve body in the other direction of the rotation direction via the biasing member.
